(19) United States
(12) Patent Application Publication
(10) Pub. No.: US 2026/0059463 A1
(43) Pub. Date: Feb. 26, 2026

(54) User Equipment Reuse of Timing Advance Obtained during Data Reception for Subsequent Data Transmission

(71) Applicant: Telefonaktiebolaget LM Ericsson (publ), Stockholm (SE)

(72) Inventors: Oskar Myrberg, Norrköping (SE); Andreas Höglund, Solna (SE); Jan Christoffersson, Luleå (SE); Revathy Narayanan, Sollentuna (SE); Sandeep Narayanan Kadan Veedu, Täby (SE)

(21) Appl. No.: 19/103,733

(22) PCT Filed: Aug. 23, 2023
(86) PCT No.: PCT/SE2023/050855

§ 371 Date: Feb. 13, 2025

Related U.S. Application Data
(60) Provisional application No. 63/400,192, filed on Aug. 23, 2022.

(51) Int. Cl. H04W 56/00; H04W 72/1268; H04W 74/0838

(52) U.S. Cl. CPC H04W 56/0045; H04W 72/1268; H04W 74/0838

(57) ABSTRACT

Embodiments include methods for a user equipment (UE) configured to operate in a cell served by a radio access network (RAN) node. Such methods include receiving at least the following information from the RAN node during a first procedure: downlink (DL) data associated with an application hosted by the UE, and a timing advance (TA) command applicable to UE uplink (UL) transmissions to the RAN node. Such methods include initiating a time alignment timer (TAT) in response to receiving the TA command. Such methods include, after completion of the first procedure and based on determining that the TAT has not expired, transmitting to the RAN node one or more messages according to a timing adjusted based on the TA command. Other embodiments include complementary methods for a RAN node, as well as UEs and RAN nodes configured to perform such methods.

### TECHNICAL FIELD

The present disclosure relates generally to wireless networks, and more specifically to techniques for user equipment (UE) that receive data from a radio access network (RAN) and subsequently transmit responsive data with a delay that is highly variable and/or unpredictable by the RAN.

### BACKGROUND

Currently the fifth generation (5G) of cellular systems, also referred to as New Radio (NR), is being standardized within the Third-Generation Partnership Project (3GPP). NR is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases. 5G/NR was initially standardized in 3GPP Release 15 (Rel-15) and continues to evolve through subsequent releases.

FIG. 1 illustrates an exemplary high-level view of a 5G network architecture, including a Next Generation RAN (NG-RAN, 199) and a 5G Core (5GC, 198). As shown in the figure, the NG-RAN can include gNBs (e.g., 110a,b) and ng-eNBs (e.g., 120a,b) connected with each other via respective Xn interfaces. The gNBs and ng-eNBs are also connected to the 5GC via respective NG interfaces, more specifically to the access and mobility management functions (AMFs, e.g., 130a,b) via respective NG-C interfaces and to the user plane functions (UPFs, e.g., 140a,b) via respective NG-U interfaces. Moreover, the AMFs can communicate with one or more policy control functions (PCFs, e.g., 150a,b) and network exposure functions (NEFs, e.g., 160a,b).

Each of the gNBs can support the NR radio interface including frequency division duplexing (FDD), time division duplexing (TDD), or a combination thereof. Each of ng-eNBs can support the fourth generation (4G) Long-Term Evolution (LTE) radio interface. Unlike conventional LTE eNBs, however, ng-e NBs connect to the 5GC via the NG interface. Each of the gNBs and ng-eNBs can serve a geographic coverage area including one or more cells (e.g., 111a-b and 121a-b). Depending on the cell in which it is located, a user equipment (UE, e.g., 105) can communicate with the gNB or ng-eNB serving that cell via the NR or LTE radio interface, respectively. Although FIG. 1 shows gNBs and ng-eNBs separately, it is also possible that a single NG-RAN node provides both types of functionality.

Each of the gNBs may include and/or be associated with a plurality of Transmission Reception Points (TRPs). Each TRP is typically an antenna array with one or more antenna elements and is located at a specific geographical location. In this manner, a gNB associated with multiple TRPs can transmit the same or different signals from each of the TRPs. For example, multiple TRPs can transmit different versions of a signal to a single UE. Each TRP can use beams for transmission/reception with UEs served by the gNB, as discussed below.

5G/NR technology shares many similarities with fourth-generation LTE. For example, NR uses CP-OFDM (Cyclic Prefix Orthogonal Frequency Division Multiplexing) in the DL and CP-OFDM or DFT-spread OFDM (DFT-S-OFDM) in the UL. As another example, in the time domain, NR DL and UL physical resources are organized into equal-sized 1-ms subframes. A subframe is further divided into multiple slots of equal duration, with each slot including multiple OFDM-based symbols. An NR slot can include 14 OFDM symbols for normal cyclic prefix and 12 symbols for extended cyclic prefix. A resource block (RB) consists of a group of 12 contiguous OFDM subcarriers for a duration of a 12- or 14-symbol slot. A resource element (RE) corresponds to one OFDM subcarrier during one OFDM symbol interval.

There has been a significant amount of 3GPP activity specifying enhancements for MTC, Machine-to-Machine (M2M), and/or Internet of Things (IoT) use cases. For example, support for narrowband IoT (NB-IoT) and MTC were introduced for LTE in Rel-13 and Rel-14. LTE Rel-15 included a feature called mobile-originated (MO) early data transmission (EDT), whereby a UE can include some small amount of data with a message transmitted to the network during a RA procedure. LTE Rel-16 included a similar feature called mobile-terminated (MT) EDT, whereby the network can include some small amount of data with a message transmitted to the UE during a RA procedure. LTE Rel-16 also included a featured called preconfigured UL resources (PUR), whereby the network assigns UEs resources that can be used to transmit some small amount of UL user data together with a message during a RA procedure. EDT and PUR are intended to reduce energy consumption and increase battery life for LTE NB-IoT and MTC-type UEs.

NR Rel-17 specified further enhancements for MO small data transmission (MO-SDT), including two solutions known as RA-SDT and configured grant (CG)-SDT. RA-SDT allows a UE to append some small amount of UL, user data to a RA message, while CG-SDT provides some contention-free resources to carry user data independent of RA messages. MO-SDT is only applicable for UEs in a radio resource control (RRC) state known as RRC_INACTIVE.

A study is ongoing about including support in NR Rel-18 for MT-SDT, including both RA-SDT and CG-SDT solutions that are similar to MO-SDT except that they involve the NG-RAN transmitting a small amount of DL user data to the UE. MT-SDT involves an SDT page of the RRC_INACTIVE UE by the NG-RAN, causing the UE to connect to the NG-RAN, after which the small amount of DL user data is transmitted to the UE.

### SUMMARY

In the proposed Rel-18 MT-SDT feature, after the DL user data has been transmitted to the UE, it is possible that the UE may need to transmit in the UL. For example, the UE may need to respond with an acknowledgement of the DL user data, and/or the UE may have UL user data needing to be transmitted. One issue is that the time between the UE receiving the MT-SDT DL user data and transmitting in the UL can vary widely and is difficult to predict. This can cause various problems and/or difficulties for the UE and the NG-RAN.

An object of embodiments of the present disclosure is to improve communication between UEs and RAN nodes, such as by providing, enabling, and/or facilitating solutions to exemplary problems summarized above and described in more detail below.

Embodiments include methods (e.g., procedures) for UE configured to operate in a cell served by a RAN node.

These exemplary methods include receiving at least the following information from the RAN node during a first procedure: DL data associated with an application hosted by the UE, and a timing advance (TA) command applicable to UE UL transmissions to the RAN node. For example, the first procedure can be an MT-SDT procedure. These exemplary methods also include initiating a time alignment timer (TAT) in response to receiving the TA command. These exemplary methods also include after completion of the first procedure and based on determining that the TAT has not expired, transmitting to the RAN node one or more messages according to a timing adjusted based on the received TA command.

In some embodiments, these exemplary methods also include receiving responsive UL data from the application after completion of the first procedure. The one or more messages are associated with the UL data. In some of these embodiments, the one or more messages include a physical uplink shared channel (PUSCH) message comprising at least a portion of the UL data. In some variants of these embodiments, the PUSCH message includes a first portion of the UL data and a buffer status report (BSR) indicating a second portion of the UL data remaining to be transmitted. In some further variants, the PUSCH message is transmitted on one of the following:
UE-specific PUSCH resources, for which the UE received a grant from the RAN node during the first procedure; or
non-UE specific PUSCH resources, which are indicated by system information (SI) broadcast in the cell.

In some further variants, the TAT is initiated to a value corresponding to a duration that the UE remains UL synchronized with the cell and the UE-specific PUSCH resources are granted at one or more instances before TAT expiration at the end of the duration. In other further variants, the UE-specific PUSCH resources are granted at one or more instances before a longest expected delay between receiving the DL data and transmitting an initial one of the messages according to a timing adjusted based on the TA command.

In some variants of these embodiments, the one or more messages transmitted according to the timing adjusted based on the received TA command also include a RA preamble, i.e., in addition to the PUSCH message. In some further variants, the RA preamble is transmitted concurrently with the PUSCH message as part of a two-step RA procedure. In some further variants, these exemplary methods also include selecting the two-step RA procedure instead of a four-step RA procedure according to one of the following:
reference signal received power (RSRP) measured in the cell is greater than an RSRP threshold that is lower than a second RSRP threshold associated with a default timing for the RA preamble and the PUSCH message; or
independent of any RSRP thresholds associated with distance from an antenna associated with the cell.

In some further variants, the RA preamble is a CBRA preamble. In other further variants, the RA preamble is a CFRA preamble, which is included or identified in the information received from the RAN node during the first procedure. In some further variants, the CFRA preamble is one of a plurality of CFRA preambles included or identified in the information received from the RAN node during the first procedure. Each of the plurality of CFRA preambles is associated with a different size of PUSCH resources. Additionally, these exemplary methods also include selecting the CFRA preamble from the plurality of CFRA preambles based on an amount of PUSCH resources needed to carry the UL data.

In some further variants, these exemplary methods also include receiving from the RAN node a physical downlink control channel (PDCCH) message including a grant of UL resources to carry the UL data. The grant of UL resources is based on the size of PUSCH resources associated with the transmitted CFRA preamble. In such case, the PUSCH message is transmitted on the granted UL resources.

In some of these embodiments, the one or more messages also include a scheduling request (SR) for UL resources to carry the UL data, i.e., in addition to the PUSCH message. In such embodiments, these exemplary methods also include, in response to the SR, receiving from the RAN node a PDCCH message including a grant of UL resources to carry the UL data. In such case, the PUSCH message is transmitted on the granted UL resources.

In some variants of these embodiments, the information received from the RAN node during the first procedure also includes a UE-specific radio network temporary identifier (RNTI). In such case, the SR is transmitted on one of the following:
UE-specific physical uplink control channel (PUCCH) resources, for which the UE received a grant from the RAN node during the first procedure; or
non-UE-specific PUCCH resources, which are indicated by system information (SI) broadcast in the cell.

In some further variants, when the SR is transmitted on non-UE-specific PUCCH resources, the PDCCH message is addressed to an RNTI common to multiple UEs in the cell and the PUSCH message includes the UE-specific RNTI. In other further variants, when the SR is transmitted on UE-specific PUCCH resources, the PDDCH message is addressed to the UE-specific RNTI.

In some variants of these embodiments, when the PDCCH message is received together with an updated TA command, the PUSCH message is transmitted according to a timing adjusted based on the updated TA command.

Other embodiments include exemplary methods (e.g., procedures) for a RAN node configured to communicate with UEs via a cell. These embodiments are complementary to UE embodiments summarized above.

These exemplary methods include transmitting at least the following information to a UE during a first procedure: DL data associated with an application hosted by the UE, and a TA command applicable to UE UL transmissions to the RAN node. For example, the first procedure can be an MT-SDT procedure. These exemplary methods also include, after completion of the first procedure and before expiration of a time alignment timer (TAT) initiated by the UE in response to the TA command, receiving from the UE one or more messages according to a timing based on the TA command.

In some embodiments, the one or more messages are associated with responsive UL data from the application. In some of these embodiments, the one or more messages include a PUSCH message comprising at least a portion of the UL data.

In some variants of these embodiments, the one or more messages do not include a RA preamble and receiving the one or more messages includes detecting the PUSCH message based on performing blind decoding of PUSCH candidates. In some further variants, the information transmitted to the UE during the first procedure also includes a CFRA preamble, such that detecting the PUSCH message in sub-block 821 is based on performing blind decoding of PUSCH candidates in PUSCH resources associated with the CFRA preamble.

In other variants of these embodiments, the PUSCH message includes a first portion of the UL data and a BSR indicating a second portion of the UL data remaining to be transmitted. In some further variants, the PUSCH message is received on UE-specific PUSCH resources, for which the RAN node transmitted a grant to the UE during the first procedure. In other further variants, the PUSCH message is received on non-UE specific PUSCH resources, which are indicated by system information broadcast in the cell.

In some further variants, the TAT is initiated to a value corresponding to a duration that the UE remains UL synchronized with the cell and the UE-specific PUSCH resources are granted at one or more instances before TAT expiration at the end of the duration. In other further variants, the UE-specific PUSCH resources are granted at one or more instances before a longest expected delay between transmitting the DL data and receiving an initial one of the messages according to a timing based on the TA command.

In some variants of these embodiments, the one or more messages received according to the timing based on the TA command also include a RA preamble, i.e., in addition to the PUSCH message. In some further variants, the RA preamble is received concurrently with the PUSCH message as part of a two-step RA procedure. In some further variants, use of the two-step RA procedure instead of a four-step RA procedure is according to one of the following:
an RSRP threshold that is lower than a second RSRP threshold associated with a default timing for the RA preamble and the PUSCH message; or
independent of any RSRP thresholds associated with distance from an antenna associated with the cell.

In some further variants, the RA preamble is a CBRA preamble. In other further variants, the RA preamble is a CFRA preamble, which is included or identified in the information transmitted to the UE during the first procedure.

In some further variants, the CFRA preamble is one of a plurality of CFRA preambles included or identified in the information transmitted to the UE during the first procedure, and each of the plurality of CFRA preambles is associated with a different size of PUSCH resources. In some further variants, these exemplary methods also include transmitting to the UE a PDCCH message including a grant of UL resources to carry the UL data. The grant of UL resources is based on the size of PUSCH resources associated with the received CFRA preamble, and the PUSCH message is received on the granted UL resources.

In some variants of these embodiments, the one or more messages received according to the timing based on the TA command also include a SR for UL resources to carry the UL data, i.e., in addition to the PUSCH message. In addition, these exemplary method also include, in response to the SR, transmitting to the UE a PDCCH message including a grant of UL resources to carry the UL data. In such case, the PUSCH message is received on the granted UL resources.

In some further variants, the information transmitted to the UE during the first procedure also includes a UE-specific RNTI and the SR is received on one of the following:
UE-specific PUCCH resources, for which the RAN node transmitted a grant to the UE during the first procedure; or
non-UE-specific PUCCH resources, which are indicated by SI broadcast in the cell.

In some further variants, when the SR is received on non-UE-specific PUCCH resources, the PDCCH message is addressed to an RNTI common to multiple UEs in the cell, and the PUSCH message includes the UE-specific RNTI. In other further variants, when the SR is received on UE-specific PUCCH resources, the PDDCH message is addressed to the UE-specific RNTI.

In some further variants, when the PDCCH message is transmitted together with an updated TA command, the PUSCH message is received according to a timing based on the updated TA command.

Other embodiments include UEs (e.g., NB-IoT UEs) and RAN nodes (e.g., base stations, eNBs, gNBs, ng-eNBs, etc., or components thereof) configured to perform operations corresponding to any of the exemplary methods described herein. Other embodiments include non-transitory, computer-readable media storing program instructions that, when executed by processing circuitry, configure such UEs or RAN nodes to perform operations corresponding to any of the exemplary methods described herein.

These and other embodiments described herein can provide various benefits and/or advantages. For example, embodiments can increase likelihood of successful decoding of UE UL traffic since a RAN node will receive a UE's msgA PUSCH transmission correctly time-aligned, whereas in conventional solutions the RAN node must apply a time shift based on reception of the msgA RA preamble. Likewise, embodiments facilitate use of the more efficient, two-step RA by UEs located further away from the RAN node as compared to conventional techniques. Embodiments can also facilitate direct UE transmission in PUSCH or PUCCH resources based on a stored TA value without transmitting an accompanying RA preamble, thereby reducing PRACH load. Embodiments provide such benefits and/or advantages without requiring any reservation of UL resources for a UE response to MT-SDT, which is beneficial in cases of no response or a response with indeterminate latency.

These and other objects, features, and advantages of embodiments of the present disclosure will become apparent upon reading the following Detailed Description in view of the Drawings briefly described below.

### BRIEF DESCRIPTION OF THE DRAWINGS

FIG. 1 shows a high-level view of an exemplary 5G/NR network architecture.

FIG. 2 shows exemplary NR user plane (UP) and control plane (CP) protocol stacks.

FIG. 3 shows an exemplary time-frequency resource grid for an NR slot.

FIG. 4, which includes FIGS. 4A-B, shows a four-step contention-based RA (CBRA) procedure and a contention-free RA (CFRA) procedure between a UE and a RAN node.

FIG. 5 shows an exemplary two-step CBRA procedure between a UE and a RAN node.

FIG. 6 shows an exemplary procedure between a UE and a RAN node, according to various embodiments of the present disclosure.

FIG. 7 shows a flow diagram of an exemplary method for a UE (e.g., wireless device), according to various embodiments of the present disclosure.

FIG. 8 shows a flow diagram of an exemplary method for a RAN node (e.g., base station, eNB, gNB, ng-eNB, etc.), according to various embodiments of the present disclosure.

FIG. 9 shows a communication system according to various embodiments of the present disclosure.

FIG. 10 shows a UE according to various embodiments of the present disclosure.

FIG. 11 shows a network node according to various embodiments of the present disclosure.

FIG. 12 shows host computing system according to various embodiments of the present disclosure.

FIG. 13 is a block diagram of a virtualization environment in which functions implemented by some embodiments of the present disclosure may be virtualized.

FIG. 14 illustrates communication between a host computing system, a network node, and a UE via multiple connections, at least one of which is wireless, according to various embodiments of the present disclosure.

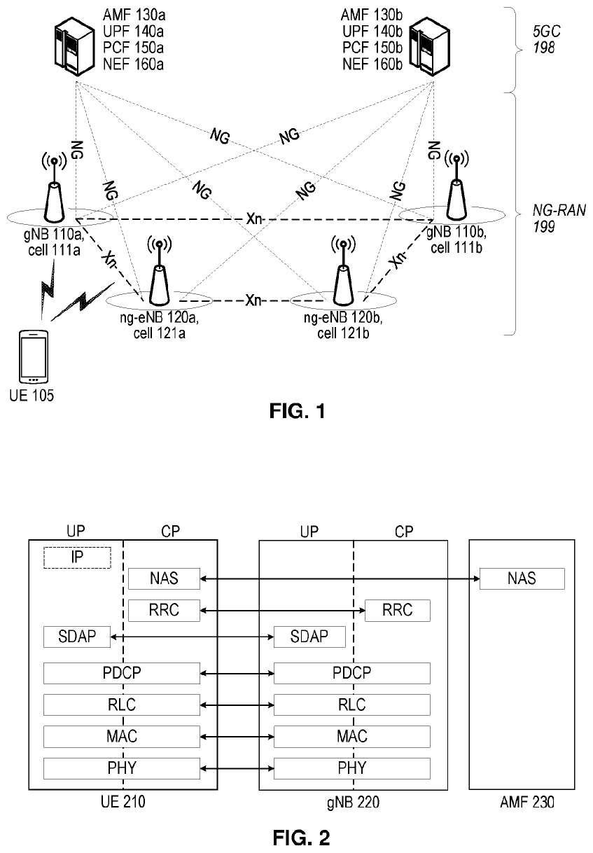

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

In general, all terms used herein are to be interpreted according to their ordinary meaning to a person of ordinary skill in the relevant technical field, unless a different meaning is expressly defined and/or implied from the context of use. All references to a/an/the element, apparatus, component, means, step, etc. are to be interpreted openly as referring to at least one instance of the element, apparatus, component, means, step, etc., unless explicitly stated otherwise or clearly implied from the context of use. The operations of any methods and/or procedures disclosed herein do not have to be performed in the exact order disclosed, unless an operation is explicitly described as following or preceding another operation and/or where it is implicit that an operation must follow or precede another operation. Any feature of any embodiment disclosed herein can apply to any other disclosed embodiment, as appropriate. Likewise, any advantage of any embodiment described herein can apply to any other disclosed embodiment, as appropriate.

Furthermore, the following terms are used throughout the description given below:
Radio Access Node: As used herein, a “radio access node” (or equivalently “radio network node,” “radio access network node,” or “RAN node”) can be any node in a radio access network (RAN) that operates to wirelessly transmit and/or receive signals. Some examples of a radio access node include, but are not limited to, a base station (e.g., gNB in a 3GPP 5G/NR network or an enhanced or eNB in a 3GPP LTE network), base station distributed components (e.g., CU and DU), a high-power or macro base station, a low-power base station (e.g., micro, pico, femto, or home base station, or the like), an integrated access backhaul (IAB) node, a transmission point (TP), a transmission reception point (TRP), a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a PDN Gateway (P-GW), a Policy and Charging Rules Function (PCRF), an access and mobility management function (AMF), a session management function (SMF), a user plane function (UPF), a Charging Function (CHF), a Policy Control Function (PCF), an Authentication Server Function (AUSF), a location management function (LMF), or the like.
Wireless Device: As used herein, a “wireless device” (or “WD” for short) is any type of device that is capable, configured, arranged and/or operable to communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with the term “user equipment” (or “UE” for short), with both terms having a different meaning than the term “network node”.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Node: As used herein, the term “node” (without prefix) can be any type of node that can in or with a wireless network (including RAN and/or core network), including a radio access node (or equivalent term), core network node, or wireless device. However, the term “node” may be limited to a particular type (e.g., radio access node, IAB node) based on its specific characteristics in any given context.
Signal: As used herein, the term “signal” (or “radio signal”) without further modification can refer to any physical signal or physical channel. Examples of physical signals include various DL and UL reference signals (RS) described herein. A “physical channel” carries higher-layer information such as data or control packets. Examples of physical channels include various channels described herein such as PDSCH, PDCCH, PUSCH. PUCCH, PBCH, etc.

The above definitions are not meant to be exclusive. In other words, various ones of the above terms may be explained and/or described elsewhere in the present disclosure using the same or similar terminology. Nevertheless, to the extent that such other explanations and/or descriptions conflict with the above definitions, the above definitions should control.

Note that the description given herein focuses on a 3GPP cellular communications system and, as such, 3GPP terminology or terminology similar to 3GPP terminology is oftentimes used. However, the concepts disclosed herein are not limited to a 3GPP system and can be applied to any communication system that may benefit from them. Furthermore, although the term “cell” is used herein, it should be understood that (particularly with respect to 5G NR) beams may be used instead of cells and, as such, concepts described herein apply equally to both cells and beams.

FIG. 2 shows an exemplary configuration of NR user plane (UP) and control plane (CP) protocol stacks between a UE (210), a gNB (220), and an AMF (230). Physical (PHY), Medium Access Control (MAC), Radio Link Control (RLC), and Packet Data Convergence Protocol (PDCP) layers between UE and gNB are common to UP and CP. PDCP provides ciphering/deciphering, integrity protection, sequence numbering, reordering, and duplicate detection for both CP and UP, as well as header compression and retransmission for UP data.

On the UP side, Internet protocol (IP) packets arrive to PDCP as service data units (SDUs), and PDCP creates protocol data units (PDUs) to deliver to RLC. The Service Data Adaptation Protocol (SDAP) layer handles quality-of-service (QoS) including mapping between QoS flows and Data Radio Bearers (DRBs) and marking QoS flow identifiers (QFI) in UL and DL packets. RLC transfers PDCP PDUs to MAC through logical channels (LCH). RLC provides error detection/correction, concatenation, segmentation/reassembly, sequence numbering, reordering of data transferred to/from the upper layers. MAC provides mapping between LCHs and PHY transport channels, LCH prioritization, multiplexing into or demultiplexing from transport blocks (TBs), hybrid ARQ (HARQ) error correction, and dynamic scheduling (in gNB). PHY provides transport channel services to MAC and handles transfer over the NR radio interface, e.g., via modulation, coding, antenna mapping, and beam forming.

On the CP side, the non-access stratum (NAS) layer between UE and AMF handles UE/gNB authentication, mobility management, and security control. RRC sits below NAS in the UE but terminates in the gNB rather than the AMF. RRC controls communications between UE and gNB at the radio interface as well as the mobility of a UE between cells in the NG-RAN. RRC also broadcasts system information (SI) and performs establishment, configuration, maintenance, and release of DRBs and Signaling Radio Bearers (SRBs) and used by UEs. Additionally, RRC controls addition, modification, and release of carrier aggregation (CA) and dual-connectivity (DC) configurations for UEs, and performs various security functions such as key management.

After a UE is powered ON it will be in the RRC_IDLE state until an RRC connection is established with the network, at which time the UE will transition to RRC_CONNECTED state (e.g., where data transfer can occur). The UE returns to RRC_IDLE after the connection with the network is released. In RRC_IDLE state, the UE's radio is active on a discontinuous reception (DRX) schedule configured by upper layers. During DRX active periods (also referred to as “DRX On durations”), an RRC_IDLE UE receives SI broadcast in the cell where the UE is camping, performs measurements of neighbor cells to support cell reselection, and monitors a paging channel on PDCCH for pages from 5GC via gNB. An NR UE in RRC_IDLE state is not known to the gNB serving the cell where the UE is camping. However, NR RRC includes an RRC_INACTIVE state in which a UE is known (e.g., via UE context) by the serving gNB. RRC_INACTIVE has some properties similar to a “suspended” condition used in LTE.

In 3GPP Release-15 (Rel-15), an NR UE can be configured with up to four carrier bandwidth parts (BWPs) in the DL with a single DL BWP being active at a given time. A UE can be configured with up to four BWPs in the UL with a single UL BWP being active at a given time. If a UE is configured with a supplementary UL (SUL), the UE can be configured with up to four additional BWPs in the SUL, with a single SUL BWP being active at any time.

Common RBs (CRBs) are numbered from 0 to the end of the carrier bandwidth. Each BWP configured for a UE has a common reference of CRB0, such that a configured BWP may start at a CRB greater than zero. CRB0 can be identified by one of the following parameters provided by the network, as further defined in 3GPP TS 38.211 section 4.4:
PRB-index-DL-common for DL in a primary cell (PCell, e.g., PCell or PSCell);
PRB-index-UL-common for UL in a PCell;
PRB-index-DL-Dedicated for DL in a secondary cell (SCell);
PRB-index-UL-Dedicated for UL in an SCell; and
PRB-index-SUL-common for a supplementary UL.

In this manner, a UE can be configured with a narrow BWP (e.g., 10 MHz) and a wide BWP (e.g., 100 MHz), each starting at a particular CRB, but only one BWP can be active for the UE at a given point in time. Within a BWP, PRBs are defined and numbered in the frequency domain from 0 to

$${N}_{BWP , i}^{size} - 1 ,$$

where/is the index of the BWP for the carrier.

NR supports various SCS values Δf=(15×2^{μ}) kHz, where μ∈(0,1,2,3,4) are referred to as “numerologies.” Numerology μ=0 (i.e., Δf=15 kHz) provides the basic (or reference) SCS that is also used in LTE. The symbol duration, cyclic prefix (CP) duration, and slot duration are inversely related to SCS or numerology. For example, there is one (1-ms) slot per subframe for Δf=15 kHz, two 0.5-ms slots per subframe for Δf=30 kHz, etc. In addition, the maximum carrier bandwidth is directly related to numerology according to 2^{μ*50} MHz. Different DL and UL numerologies can be configured by the network.

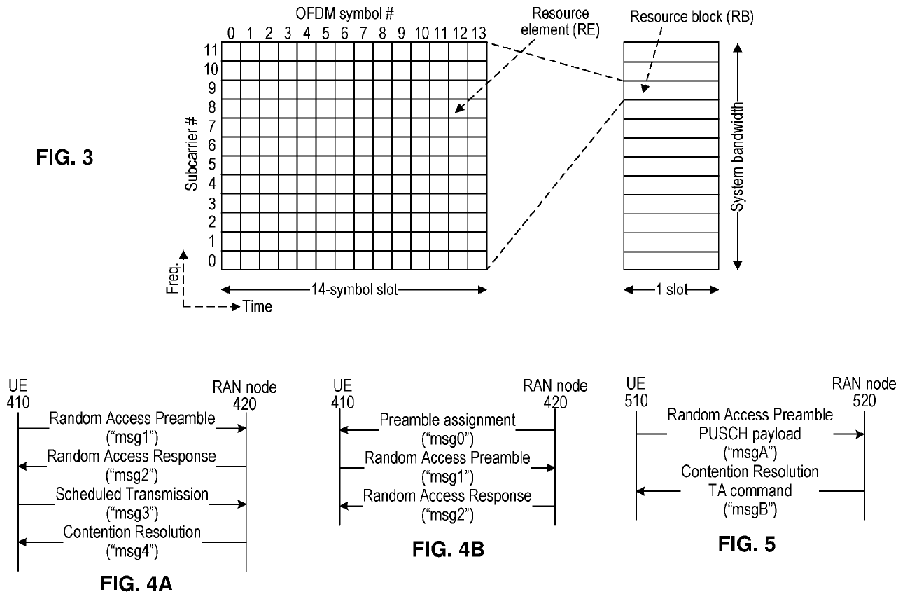

FIG. 3 shows an exemplary time-frequency resource grid for an NR slot. As illustrated in FIG. 3, a resource block (RB) consists of a group of 12 contiguous OFDM subcarriers for a duration of a 14-symbol slot. Like in LTE, a resource element (RE) consists of one subcarrier in one symbol. An NR slot can include 14 OFDM symbols for normal cyclic prefix and 12 symbols for extended cyclic prefix.

In general, an NR physical channel corresponds to a set of REs carrying information that originates from higher layers. Downlink (DL, i.e., RAN node to UE) physical channels include Physical Downlink Shared Channel (PDSCH), Physical Downlink Control Channel (PDCCH), and Physical Broadcast Channel (PBCH). Uplink physical channels include Physical Uplink Shared Channel (PUSCH), Physical Uplink Control Channel (PUCCH), and Physical Random-Access Channel (PRACH). PUSCH is the uplink counterpart to the PDSCH. PUCCH is used by UEs to transmit uplink control information (UCI) including HARQ feedback for RAN node DL transmissions, channel quality feedback (e.g., CSI) for the DL channel, scheduling requests (SRs), etc. PRACH is used for random access preamble transmission.

FIG. 4, which includes FIGS. 4A-B, shows two exemplary random access (RA) procedures for a UE. In general, a UE can perform a RA procedure during various situations such as initial access from RRC_IDLE or RRC_INACTIVE, RRC connection re-establishment, handover, and UL or DL data arrival in RRC_CONNECTED when the UE is unsynchronized with its serving RAN node (e.g., gNB). In the following description of FIGS. 4A-B, UE (410) and RAN node (420) will be referred to without their reference numbers.

FIG. 4A shows an exemplary contention-based RA (CBRA) procedure. In this procedure, the UE initially selects one of the RA preambles available in a cell and transmits it on PRACH to the RAN node serving that cell. This transmission is referred to as “msg1.” If the RAN node receives the preamble correctly (due to, e.g., no collisions with other UEs transmitting the same preamble), it sends a random-access response (RAR, also referred to as “msg2”) to the UE via PDSCH. Typically, the RAR includes a timing advance (TA) command for alignment of subsequent UE transmissions, a grant of UL resources for subsequent UE transmission (“UL grant”) on PUSCH, and a temporary identifier assigned to the UE in the cell (“C-RNTI”). If the UE correctly receives the RAR, it responds with the transmission scheduled by the UL grant in the RAR and includes the C-RNTI assigned by the RAR. This transmission is also referred to as “msg3.” If the eNB correctly receives msg3, it responds with a contention resolution message (“msg4”).

Upon receiving and applying the TA command, the UE starts a time alignment timer (TAT) with an initial value that was previously configured by the RAN via unicast RRC signaling or broadcast SI in the cell. While the TAT is running and not expired, the UE considers itself UL synchronized in the cell and can transmit without receiving another TA command. If the TAT expires without the UE receiving another TA command in the cell, the UE becomes UL unsynchronized in the cell and must perform a RA procedure to obtain another TA command before any UL transmissions.

FIG. 4B shows a contention-free RA (CFRA) procedure. In this procedure, the RAN node initially transmits an assignment (“msg0”) of a specific RA preamble for the UE to use when accessing a cell. For example, msg0 can be an RRC MobilityControlInfo IE sent by a source RAN node during preparation of UE handover to a target cell where it must perform a RA procedure. As another example, msg0 can be DCI over PDCCH, which the RAN node sends to inform the UE of DL data arrival and to instruct the UE to perform RA using the indicated preamble.

Subsequently, the UE transmits the assigned RA preamble (“msg1”) and, if received correctly, the RAN node sends a RAR (“msg2”). Since the assigned preamble removes the possibility of contention/collision, the CBRA procedure does not include exchange of msg3 and msg4. As such, CFRA has lower latency than CBRA.

NR Rel-16 also includes a simplified two-step CBRA procedure that reduces RA latency in a similar manner as CFRA but without requiring reserved RA preambles. FIG. 5 shows an exemplary two-step CBRA procedure. Initially, a UE (510) transmits a msgA, which includes a RA preamble on PRACH and a payload on PUSCH. The payload corresponds to the msg3 in the four-step CBRA shown in FIG. 4A. The UE may obtain information about PUSCH resources to use for transmission from broadcast SI (e.g., when the UE is not in RRC_CONNECTED) or during a handover procedure to the cell (e.g., when the UE is in RRC_CONNECTED).

If the RAN node successfully detects the RA preamble on PRACH and successfully decodes the payload on PUSCH, it transmits a msgB on PDSCH. The msgB notifies the UE of the contention resolution and includes an RAR and a TA command for the UE to use for subsequent UL transmissions. Alternately, if the RAN node detects the RA preamble but fails to decode the payload on PUSCH, it sends back a fallback RAR to the UE with the TA command and an uplink grant for the payload retransmission. Alternately, if the RAN node detects multiple (colliding) versions of the RA preamble transmitted by different UEs, it transmits a backoff indication which tells the UEs to attempt another RA according to preconfigured backoff rules.

Conventionally, the UE and RAN node can communicate user data only after completion of the RA procedure. As mentioned above, however, LTE Rel-15 included a feature called mobile-originated (MO) early data transmission (EDT), whereby a UE can include some small amount of data with a message transmitted to during a RA procedure. The UE can indicate its intention to send a small amount of UL user data in msg3 by selecting an EDT-associated preamble to transmit in msg1. The RAN node (e.g., eNB) provides the UE in msg2 with an EDT UL grant that allows the UE to transmit the UL data together with conventional contents of msg3.

LTE Rel-16 included a similar feature called mobile-terminated (MT) EDT, whereby the network can include some small amount of data with a message transmitted to the UE during a RA procedure. After initially considering including data in both msg2 and msg4, Rel-16 settled on support for MT-EDT in msg4 only. LTE Rel-16 also included a featured called preconfigured uplink (UL) resources (PUR), whereby the network assigns UEs resources that can be used to transmit some small amount of UL user data together with a message during a RA procedure. EDT and PUR are intended to reduce energy consumption and increase battery life for LTE NB-IoT and MTC-type UEs.

NR Rel-17 specified further enhancements for MO small data transmission (MO-SDT) for UEs in RRC_INACTIVE state, including two solutions known as RA-SDT and configured grant (CG)-SDT. RA-SDT is applicable to both four-step CBRA (e.g., FIG. 4A) two-step CBRA (e.g., FIG. 5) procedures but allows the UE to append a UP data payload to msg3 or msgA, multiplexed with the RRCResumeRequest message conventionally included in both of those RA messages.

In CG-SDT, a UE is configured via RRC with some periodic, contention-free UL resources that can be used for MO-SDT. This enables the UE to transmit without performing steps 1-2 of a four-step CBRA, but requires that the UE have a valid TA and is UL synchronized in the cell where the transmission takes place.

A study is ongoing about support in NR Rel-18 for MT-SDT for RRC_INACTIVE UES. MT-SDT involves a NG-RAN sending an SDT page to an RRC_INACTIVE UE, causing the UE to connect to the NG-RAN, after which the NG-RAN node can transmit a small amount of DL user data to the UE. In this manner, MO-SDT is triggered by DL data transmissions. How the UE connects to the NG-RAN is not specified, but could be based on similar procedures as RA-SDT, CG-SDT, four-step CBRA, two-step CBRA, and CFRA.

One possible application-level use case for MT-SDT is client-server polling, where the server sends a message to the client (i.e., in UE) via DL user data, and the client sends a response to the server via UL user data. The response could be an acknowledgement of the message (e.g., a TCP-layer ACK) or specific application-level data such as sensor readings, etc. Furthermore, there may be one or more subsequent messages exchanged between server and client.

Thus, one of the goals of the Rel-18 study is to specify an MT-SDT procedure that includes both initial DL data transmission and subsequent UL/DL data transmissions. In general, however, the timing of a UE response with UL user data after receipt of initial DL user data is unknown and/or difficult to predict from the perspective of the serving RAN node. For example, the latency of the UE response may range from 100 ms to 20 seconds, depending on factors such as application being used, type of UE, UE measurement schedule, etc. Many of these are unknown and/or out of control of the RAN node.

As such, it is difficult for the RAN node to decide whether to reserve UL resources for the UE to use for transmission of the responsive UL user data. If the latency is relatively small, it may be beneficial for the RAN node to reserve some UL resources to improve efficiency. But if the latency is relatively large—or if no UL user data will be transmitted—it would be a wasteful to reserve UL resources for the UE. However, if no resources are reserved and the UE needs to transmit responsive UL user data, the UE will be required to exchange various signaling messages with the RAN node to obtain the needed UL resources, which increases UE energy consumption.

Accordingly, embodiments of the present disclosure provide flexible and efficient techniques whereby at the time of an UL response to a previous DL data transfer (SDT or otherwise), a UE checks its TAT to verify that its current TA value obtained from the previous DL transfer is still valid. If so, the UE performs an UL transmission with timing adjusted according to the still-valid TA value. In some variants, the UE performs a two-step RA procedure by transmitting a RA preamble with accompanying PUSCH payload, which can include an RRC message (e.g., RRCResumeRequest as in Rel-16 two-step CBRA) and optionally a small amount of UL user data (e.g., as in Rel-17 MO RA-SDT). In conventional techniques, a UE applies a default value of TA=0 to these transmissions.

In other variants, the UE can transmit the PUSCH payload resource with timing adjusted according to the still-valid TA, while refraining from transmitting an accompanying RA preamble on PRACH. These variants are advantageous in that the UE does not consume limited PRACH resources or requiring configuration of periodic PDCCH or PDSCH resources for the possible event of a response in UL.

Embodiments can provide various benefits and/or advantages. For example, embodiments can increase likelihood of successful decoding of UL traffic since the RAN node will receive the UE's msgA PUSCH transmission correctly time-aligned, whereas in conventional solutions the RAN node must apply a time shift based on reception of the msgA RA preamble. Likewise, embodiments facilitate use of the more efficient, two-step RA by UEs located further away from the RAN node as compared to conventional techniques. Embodiments can also facilitate direct UE transmission in PUSCH or PUCCH resources based on a stored TA value without transmitting an accompanying RA preamble, thereby reducing PRACH load. Embodiments provide such benefits and/or advantages without requiring any reservation of UL resources for a UE response to MT-SDT, which is beneficial in cases of no response or a response with indeterminate latency.

When a UE is in RRC_CONNECTED state, it has a valid TA to synchronize uplink transmissions, a C-RNTI to allow for HARQ retransmission and dedicated handling by the RAN, and a dedicated configuration and assigned resources (e.g., periodic PUCCH resources). Embodiments of the present disclosure exploit the valid TA and/or the valid C-RNTI from a previous/earlier MT-SDT (or legacy data transmission) for a subsequent UL response.

In various embodiments, a previously obtained but still valid TA is reused for two-step RA (Rel-15/16) or two-step RA-SDT (Rel-17), either with or without the use of CFRA preamble (earlier provided during the MT-SDT procedure). In some embodiments, the UE transmits msgA PUSCH and msgA preamble with a timing adjusting based on the still-valid TA. In other embodiments, the UE transmits msgA PUSCH with a timing adjusting based on the still-valid TA but refrains from transmitting a msgA preamble.

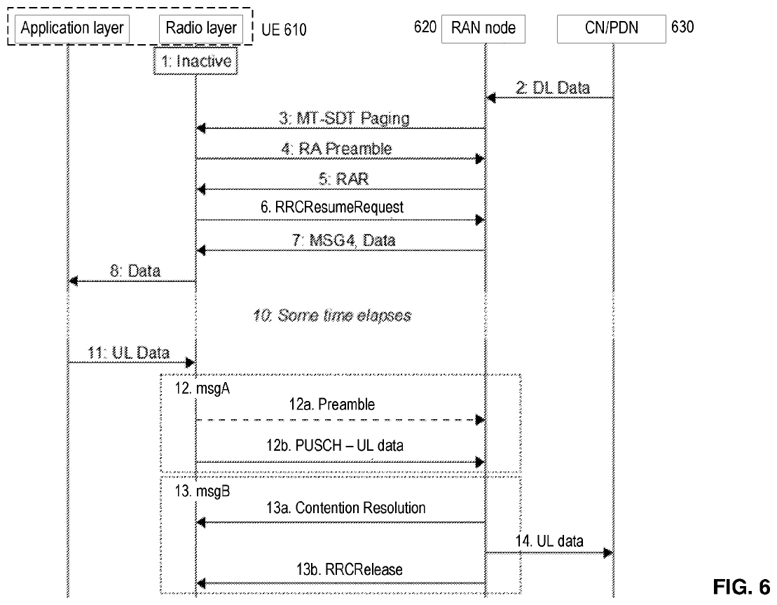

FIG. 6 shows an exemplary procedure between a UE (610), a RAN node (620), and a core network and/or packet data network (CN/PDN, 630), according to various embodiments of the present disclosure. For example, the CN may be a 5GC and the PDN may be an IP multimedia system (IMS), the Internet, a private data network, etc. Although the operations shown in FIG. 6 are given numerical labels, this is intended to facilitate explanation rather than to imply or require any sequential order of the operations, unless expressly stated otherwise.

In operation 1, the UE radio layer is in RRC_INACTIVE state. In operation 2, the RAN node receives DL data from the CN/PDN. The DL data is intended for the UE application layer. Operations 3-7 between the RAN node and the UE radio layer can represent an MT-SDT procedure such as being considered for 3GPP Rel-18. In other words, the MT-SDT procedure can be considered completed after operation 7.

In operation 3, the RAN node sends an MT-SDT paging signal to the UE. In operation 4, upon receiving the paging signal, the UE responds by transmitting a RA preamble. In some variants, the RA preamble may be indicated by the paging signal. In operation 5, the RAN node sends a RAR, which can include a TA command and a PUSCH resource assignment for UE transmission of an RRCResumeRequest message.

In operation 6, the UE adjusts its timing according to the TA command, initiates a TAT according to a configured initial value, and transmits the RRCResumeRequest using the allocated PUSCH resources and the adjusted timing. In operation 7, the RAN node transmits the DL data received in operation 2 to the UE via PDSCH, which may be scheduled via PDCCH.

In operation 8, the UE radio layer forwards the received DL data to the UE application layer. In operation 10, some duration of time passes while the UE application layer digests the DL data and generates responsive UL data, with the duration being variable and/or unpredictable. In operation 11, the UE application layer provides the UL data to the UE radio layer.

In operation 12, the UE (radio layer) determines that the TAT is still running and has not expired, such that the TA value received in operation 5 is still valid. In operation 12a, the UE transmits at least a portion of the UL data via PUSCH with a timing adjusted based on the still-valid TA value. In some embodiments, the UE also transmits a RA preamble in operation 12b. Operation 12, including 12a and optionally 12b, can be considered a variant of msgA in a two-step CBRA procedure.

In operation 13, the RAN node responds with a contention resolution indicator (13a) and an RRCRelease message (13b). Operation 13, including 13a-b, can be considered a variant of msgB in a two-step CBRA procedure. In operation 14, the RAN node forwards the received UL data to the CN/PDN.

The following description of detailed embodiments and variants is based on the above description of FIG. 6 as context. Conventionally, the msgA RA preamble has two purposes: 1) to assist the RAN node with obtaining timing for the PUSCH transmission; and 2) to inform the RAN node that PUSCH is transmitted and that RAN node decoding is needed.

In variants where the UE transmits a RA preamble with msgA, the RAN node can operate in a conventional manner with respect to PUSCH decoding (purpose 2 above). In variants where the UE transmits PUSCH without a RA preamble, the RAN node needs to perform blind decoding of PUSCH. If the UE was previously assigned a CFRA preamble, the blind decoding can be limited to PUSCH resources mapped to the CFRA preamble, even though the UE does not transmit the CFRA preamble itself.

In both variants, the UE transmits msgA PUSCH with a timing adjusted based on the still-valid TA which causes the PUSCH to be received within an allowable range in the RAN node's receive timing structure. In some embodiments, the UE can also include the previously assigned C-RNTI (or other identifier, such as MT-RNTI) with the PUSCH transmission to facilitate HARQ retransmissions as needed.

In different embodiments, the PUSCH resources available for UE transmission of msgA PUSCH with a timing adjusted based on the still-valid TA can be UE-specific (i.e., dedicated/assigned to each UE) or common/shared among multiple UEs. In the UE-specific case, the PUSCH resources can be scheduled along with resources for the RRCRelease+Msg4 in PDCCH addressed to the UE's C-RNTI (or MT-RNTI). In the shared case, the common PUSCH resources are indicated by broadcast SI in the cell.

In both cases, the PUSCH resources can be allocated to contain a fixed size transport block (TB) of data, according to MT-SDT specifications. For example, the allocated PUSCH resources could be compatible with the DVT set for the Rel-17 MO-SDT transmissions. Alternatively, in the UE-specific case, the RAN node can allocate PUSCH resources with variable TB size configured according to application needs and/or requirements.

In some embodiments, a UE can transmit the maximum amount of data within the allocated (UE-specific or shared) PUSCH resources, and any remaining data can be transmitted as subsequent transmissions. For example, the UE can request additional PUSCH resources by sending a buffer status report (BSR) together with the initial transmission of UL data in the allocated PUSCH resources. In response, the RAN node can provide the UL grant optionally with a new TA command (MAC CE), as needed.

Conventionally, the use of two-step RA (either legacy or SDT) requires that the UE's measured RSRP is above a threshold. This ensures that the UE is close enough to the serving RAN node so that the use of default TA=0 will enable the RAN node to correctly decode the UE's PUSCH transmission and that the UE will not interfere with other UEs in the UL. In some embodiments of the present disclosure, since the UE is using a still-valid TA instead of default TA=0, the UE can use a lower RSRP threshold for selecting two-step RA or can refrain from checking RSRP against a threshold when using two-step RA.

It is desirable to reuse the still-valid TA also in a four-step RA procedure, such that the UE can avoid the exchange of msg1/msg2 which has a primary purpose of establishing UE time alignment for subsequent UE transmission of msg3. However, msg3 also requires an UL grant of PUSCH resources, which is conventionally received in msg2.

In some embodiments, a delayed UL grant is provided to the UE as part of the earlier MT-SDT procedure. For example, the delayed UL grant can be included in msg4 (FIG. 6 operation 7) together with DL data (and RRCRelease, if included). The delayed timing of the UL grant can encompass the longest expected delay (optionally plus some UE processing delay and safety margin).

As another example, the delayed timing of the UL grant can match the TAT expiration for the MT-SDT procedure (optionally minus some UE processing delay and safety margin). In this approach, the UE is assured of an opportunity to transmit an UL response before TAT expiration, after which the UE needs to perform CBRA to obtain a valid TA before transmitting the UL response.

In some embodiments, the RAN node can send the UE a CRFA preamble for later use with responsive UL data, during the MT-SDT procedure. For example, the RAN node can indicate a CFRA preamble in msg4 sent in FIG. 6 operation 7. The RAN node can associate the provided CFRA preamble with the C-RNTI assigned to the UE. When the UE transmits the provided CFRA preamble in operation 12a, the gNB identifies the UE C-RNTI from the received CFRA preamble and sends an UL grant. However, the RAN node does not need to send the UL grant in a RAR on PDSCH as done conventionally; rather, the RAN node can more efficiently send a DCI addressed to the UEs C-RNTI.

In a variant of these embodiments, the RAN node can indicate multiple CFRA preambles to the UE in operation 7, with each CFRA preamble mapping to a different UL grant size. In this case, the UE uses the CFRA preamble (operation 12a) that maps to an UL grant size that is sufficient to carry the UL data received from the UE application layer.

Reusing the still-valid TA also enables the UE to transmit PUCCH without interfering with other UEs at the RAN node receiver. In some embodiments, the UE can transmit PUCCH with a timing adjusted based on the still-valid TA to request an UL grant of PUSCH resources to send the UL data to the RAN node. For example, the PUCCH can carry a scheduling request (SR). The UE can be assigned either UE-specific PUCCH SR resources or use PUCCH SR resources that are shared by all UEs needing to transmit UL response in an MT-SDT procedure.

For UE-specific PUCCH SR resources, the identity of the UE would be implicit from the PUCCH resources in which the RAN node received the SR. Therefore, PDCCH carrying the scheduling information (DCI) for PUSCH can be addressed to the C-RNTI (or UE-specific MT-RNTI) previously assigned to the UE. Note that the UE would need to start monitoring the PDCCH search space only after transmitting PUCCH, which reduces UE energy consumption. UE-specific PUCCH SR resources can be provided/indicated to the UE during the MT-SDT procedure, in a similar manner as the delayed UL grant discussed above.

For shared (or common) PUCCH SR resources, the UE identity is not implicit from the PUCCH resources in which the RAN node received the SR. In such embodiments, when the RAN node transmits a responsive PDCCH DCI carrying scheduling information for PUSCH, the DCI can be addressed to an RNTI that is common to multiple UEs in the cell. Subsequently, the UE can provide its assigned C-RNTI (or MT-RNTI) with the scheduled PUSCH transmission, which enables the RAN node to identify the UE and resolve any contention. The common PUCCH resources to be used for a SR can be provided to the UE in SI (e.g., broadcast). This is contrary to existing 3GPP-solutions in which PUCCH SR resources are not provided to UEs in SI.

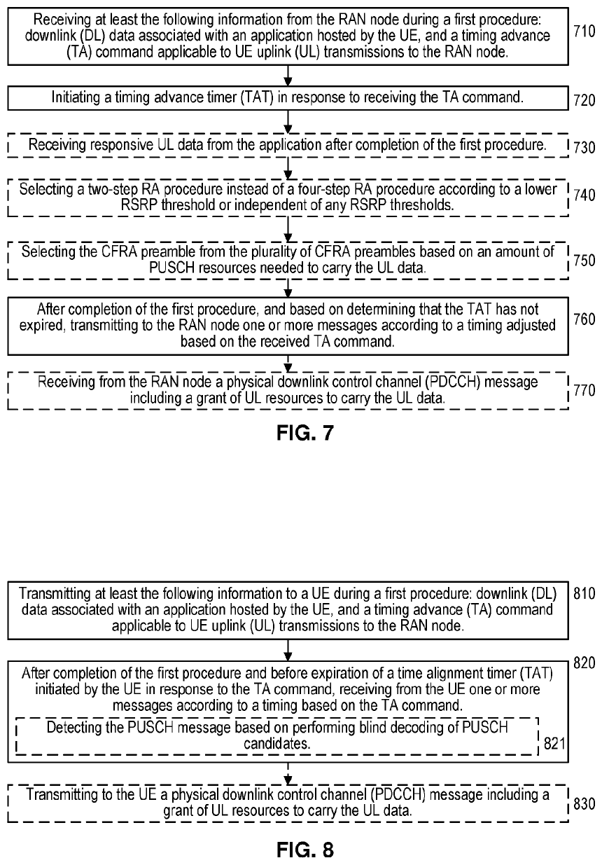

Various features of the embodiments described above correspond to various operations illustrated in FIGS. 7-8, which show exemplary methods (e.g., procedures) for a UE and a RAN node, respectively. In other words, various features of the operations described below correspond to various embodiments described above. Furthermore, the exemplary methods shown in FIGS. 7-8 can be used cooperatively to provide various benefits, advantages, and/or solutions to problems described herein. Although FIGS. 7-8 show specific blocks in particular orders, the operations of the exemplary methods can be performed in different orders than shown and can be combined and/or divided into blocks having different functionality than shown. Optional blocks or operations are indicated by dashed lines.

In particular, FIG. 7 shows an exemplary method (e.g., procedure) for a UE configured to operate in a cell served by a RAN node, according to various embodiments of the present disclosure. The exemplary method can be performed by a UE (e.g., wireless device, IoT device, etc.) such as described elsewhere herein.

The exemplary method includes the operations of block 710, where the UE can receive at least the following from the RAN node during a first procedure: DL data associated with an application hosted by the UE, and a timing advance (TA) command applicable to UE UL transmissions to the RAN node. For example, the first procedure can be a mobile-terminated small data transmission (MT-SDT) procedure. The exemplary method also includes the operations of block 720, where the UE can initiate a time alignment timer (TAT) in response to receiving the TA command. The exemplary method also includes the operations of block 760, where after completion of the first procedure and based on determining that the TAT has not expired, the UE can transmit to the RAN node one or more messages according to a timing adjusted based on the TA command.

In some embodiments, the exemplary method can also include the operations of block 730, where the UE can receive responsive UL data from the application after completion of the first procedure. The one or more messages are associated with the UL data. In some of these embodiments, the one or more messages include a physical uplink shared channel (PUSCH) message comprising at least a portion of the UL data. In some variants of these embodiments, the PUSCH message includes a first portion of the UL data and a buffer status report (BSR) indicating a second portion of the UL data remaining to be transmitted. In some further variants, the PUSCH message is transmitted on one of the following:
UE-specific PUSCH resources, for which the UE received a grant from the RAN node during the first procedure; or
non-UE specific PUSCH resources, which are indicated by system information (SI) broadcast in the cell.

In some further variants, the TAT is initiated to a value corresponding to a duration that the UE remains UL synchronized with the cell and the UE-specific PUSCH resources are granted at one or more instances before TAT expiration at the end of the duration. In other further variants, the UE-specific PUSCH resources are granted at one or more instances before a longest expected delay between receiving the DL data and transmitting an initial one of the messages according to a timing adjusted based on the TA command.

In some variants of these embodiments, the one or more messages transmitted according to the timing adjusted based on the received TA command also include a RA preamble, i.e., in addition to the PUSCH message. In some further variants, the RA preamble is transmitted concurrently with the PUSCH message as part of a two-step RA procedure. In some further variants, the exemplary method can also include the operations of block 740, where the UE can select the two-step RA procedure instead of a four-step RA procedure according to one of the following:
reference signal received power (RSRP) measured in the cell is greater than an RSRP threshold that is lower than a second RSRP threshold associated with a default timing for the RA preamble and the PUSCH message; or
independent of any RSRP thresholds associated with distance from an antenna associated with the cell.

In some further variants, the RA preamble is a CBRA preamble. In other further variants, the RA preamble is a CFRA preamble, which is included or identified in the information received from the RAN node during the first procedure. In some variants, the CFRA preamble is one of a plurality of CFRA preambles included or identified in the information received from the RAN node during the first procedure. Each of the plurality of CFRA preambles is associated with a different size of PUSCH resources. Additionally, the exemplary method can also include the operations of block 750, where the UE can select the CFRA preamble (i.e., transmitted in block 760) from the plurality of CFRA preambles based on an amount of PUSCH resources needed to carry the UL data.

In some further variants, the exemplary method can also include the operations of block 770, where the UE can receive from the RAN node a physical downlink control channel (PDCCH) message including a grant of UL resources to carry the UL data. The grant of UL resources is based on the size of PUSCH resources associated with the transmitted CFRA preamble. In such case, the PUSCH message is transmitted in block 760 on the granted UL resources.

In some of these embodiments, the one or more messages also include a scheduling request (SR) for UL resources to carry the UL data, i.e., in addition to the PUSCH message. In such embodiments, the exemplary method can also include the operations of block 770, where in response to the SR, the UE can receive from the RAN node a PDCCH message including a grant of UL resources to carry the UL data. In such case, the PUSCH message is transmitted in block 760 on the granted UL resources.

In this manner, the PDCCH message received in block 770 can be intermediate between multiple messages transmitted in block 760.

In some variants of these embodiments, the information received from the RAN node during the first procedure also includes a UE-specific radio network temporary identifier (RNTI). In such case, the SR is transmitted in block 760 on one of the following:
UE-specific physical uplink control channel (PUCCH) resources, for which the UE received a grant from the RAN node during the first procedure; or
non-UE-specific PUCCH resources, which are indicated by system information (SI) broadcast in the cell.

In some further variants, when the SR is transmitted on non-UE-specific PUCCH resources, the PDCCH message is addressed to an RNTI common to multiple UEs in the cell and the PUSCH message includes the UE-specific RNTI. In other further variants, when the SR is transmitted on UE-specific PUCCH resources, the PDDCH message is addressed to the UE-specific RNTI.

In some variants of these embodiments, when the PDCCH message is received together with an updated TA command, the PUSCH message is transmitted in block 770 according to a timing adjusted based on the updated TA command (i.e., instead of based on the TA command received in block 710).

In addition, FIG. 8 shows an exemplary method (e.g., procedure) for a RAN node configured to communicate with UEs via a cell, according to various embodiments of the present disclosure. The exemplary method can be performed by a RAN node (e.g., base station, eNB, gNB, ng-eNB, etc., or component thereof) such as described elsewhere herein.

The exemplary method includes the operations of block 810, where the RAN node can transmit at least the following information to a UE during a first procedure: DL data associated with an application hosted by the UE, and a TA command applicable to UE UL transmissions to the RAN node. For example, the first procedure can be an MT-SDT procedure. The exemplary method also includes the operations of block 820, where after completion of the first procedure and before expiration of a TAT initiated by the UE in response to the TA command, the RAN node can receive from the UE one or more messages according to a timing based on the TA command.

In some embodiments, the one or more messages are associated with responsive UL data from the application. In some of these embodiments, the one or more messages include a PUSCH message comprising at least a portion of the UL data.

In some variants of these embodiments, the one or more messages do not include a RA preamble and receiving the one or more messages in block 820 includes the operations of sub-block 821, where the RAN node can detect the PUSCH message based on performing blind decoding of PUSCH candidates. In some further variants, the information transmitted to the UE during the first procedure also includes an indication of a CFRA preamble, and detecting the PUSCH message in sub-block 821 is based on performing blind decoding of PUSCH candidates in PUSCH resources associated with the CFRA preamble.

In other variants of these embodiments, the PUSCH message includes a first portion of the UL data and a BSR indicating a second portion of the UL data remaining to be transmitted. In some further variants, the PUSCH message is received on UE-specific PUSCH resources, for which the RAN node transmitted a grant to the UE during the first procedure. In other further variants, the PUSCH message is received on non-UE specific PUSCH resources, which are indicated by system information broadcast in the cell.

In some further variants, the TAT is initiated to a value corresponding to a duration that the UE remains UL synchronized with the cell and the UE-specific PUSCH resources are granted at one or more instances before TAT expiration at the end of the duration. In other further variants, the UE-specific PUSCH resources are granted at one or more instances before a longest expected delay between transmitting the DL data and receiving an initial one of the messages according to a timing based on the TA command.

In some variants of these embodiments, the one or more messages received according to the timing based on the TA command also include a RA preamble, i.e., in addition to the PUSCH message. In some further variants, the RA preamble is received concurrently with the PUSCH message as part of a two-step RA procedure. In some further variants, use of the two-step RA procedure instead of a four-step RA procedure is according to one of the following:
an RSRP threshold that is lower than a second RSRP threshold associated with a default timing for the RA preamble and the PUSCH message; or
independent of any RSRP thresholds associated with distance from an antenna associated with the cell.

In some further variants, the RA preamble is a CBRA preamble. In other further variants, the RA preamble is a CFRA preamble, which is included or identified in the information transmitted to the UE during the first procedure. In some further variants, the CFRA preamble is one of a plurality of CFRA preambles included or identified in the information transmitted to the UE during the first procedure, and each of the plurality of CFRA preambles is associated with a different size of PUSCH resources.

In some further variants, the exemplary method can also include the operations of block 830, where the RAN node can transmit to the UE a PDCCH message including a grant of UL resources to carry the UL data. The grant of UL resources is based on the size of PUSCH resources associated with the received CFRA preamble, and the PUSCH message is received in block 820 on the granted UL resources.

In some variants of these embodiments, the one or more messages received according to the timing based on the TA command also include a SR for UL resources to carry the UL data, i.e., in addition to the PUSCH message. Also, the exemplary method can also include the operations of block 830, where in response to the SR, the RAN node can transmit to the UE a PDCCH message including a grant of UL resources to carry the UL data. In such case, the PUSCH message is received on the granted UL resources.

In this manner, the PDCCH message transmitted in block 830 can be intermediate between multiple messages received in block 820.

In some further variants, the information transmitted to the UE during the first procedure also includes a UE-specific RNTI and the SR is received on one of the following:
UE-specific PUCCH resources, for which the RAN node transmitted a grant to the UE during the first procedure; or
non-UE-specific PUCCH resources, which are indicated by SI broadcast in the cell.

In some further variants, when the SR is received on non-UE-specific PUCCH resources, the PDCCH message is addressed to an RNTI common to multiple UEs in the cell, and the PUSCH message includes the UE-specific RNTI. In other further variants, when the SR is received on UE-specific PUCCH resources, the PDDCH message is addressed to the UE-specific RNTI.

In some further variants, when the PDCCH message is transmitted in block 830 together with an updated TA command, the PUSCH message is received in block 820 according to a timing based on the updated TA command (i.e., instead of based on the TA command transmitted in block 810).

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

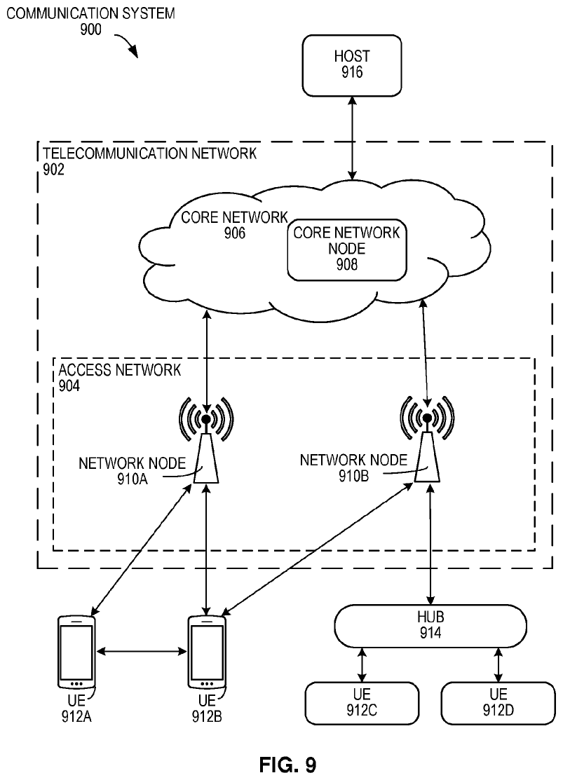

FIG. 9 shows an example of a communication system 900 in accordance with some embodiments. In this example, communication system 900 includes a telecommunication network 902 that includes an access network 904 (e.g., RAN) and a core network 906, which includes one or more core network nodes 908. Access network 904 includes one or more access network nodes, such as network nodes 910a-b (one or more of which may be generally referred to as network nodes 910), or any other similar 3GPP access node or non-3GPP access point. Network nodes 910 facilitate direct or indirect connection of UEs, such as by connecting UEs 912a-d (one or more of which may be generally referred to as UEs 912) to core network 906 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, communication system 900 may include any number of wired or wireless networks, network nodes, UEs, and/or any other components or systems that may facilitate or participate in the communication of data and/or signals whether via wired or wireless connections. Communication system 900 may include and/or interface with any type of communication, telecommunication, data, cellular, radio network, and/or other similar type of system.

UEs 912 may be any of a wide variety of communication devices, including wireless devices arranged, configured, and/or operable to communicate wirelessly with network nodes 910 and other communication devices. Similarly, network nodes 910 are arranged, capable, configured, and/or operable to communicate directly or indirectly with UEs 912 and/or with other network nodes or equipment in telecommunication network 902 to enable and/or provide network access, such as wireless network access, and/or to perform other functions, such as administration in telecommunication network 902.

In the depicted example, core network 906 connects network nodes 910 to one or more hosts, such as host 916. These connections may be direct or indirect via one or more intermediary networks or devices. In other examples, network nodes may be directly coupled to hosts. Core network 906 includes one or more core network nodes (e.g., 908) that are structured with hardware and software components. Features of these components may be substantially similar to those described with respect to the UEs, network nodes, and/or hosts, such that the descriptions thereof are generally applicable to the corresponding components of core network node 908 Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

Host 916 may be under the ownership or control of a service provider other than an operator or provider of access network 904 and/or telecommunication network 902, and may be operated by the service provider or on behalf of the service provider Host 916 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, communication system 900 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, telecommunication network 902 is a cellular network that implements 3GPP standardized features. Accordingly, telecommunication network 902 may support network slicing to provide different logical networks to different devices that are connected to telecommunication network 902. For example, telecommunication network 902 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, UEs 912 are configured to transmit and/or receive information without direct human interaction. For instance, a UE may be designed to transmit information to access network 904 on a predetermined schedule, when triggered by an internal or external event, or in response to requests from access network 904. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, hub 914 communicates with access network 904 to facilitate indirect communication between one or more UEs (e.g., UE 912c and/or 912d) and network nodes (e.g., network node 910b). In some examples, hub 914 may be a controller, router, content source and analytics, or any of the other communication devices described herein regarding UEs. For example, hub 914 may be a broadband router enabling access to core network 906 for the UEs. As another example, hub 914 may be a controller that sends commands or instructions to one or more actuators in the UEs. Commands or instructions may be received from the UEs, network nodes 910, or by executable code, script, process, or other instructions in hub 914. As another example, hub 914 may be a data collector that acts as temporary storage for UE data and, in some embodiments, may perform analysis or other processing of the data. As another example, hub 914 may be a content source. For example, for a UE that is a VR headset, display, loudspeaker or other media delivery device, hub 914 may retrieve VR assets, video, audio, or other media or data related to sensory information via a network node, which hub 914 then provides to the UE either directly, after performing local processing, and/or after adding additional local content. In still another example, hub 914 acts as a proxy server or orchestrator for the UEs, such as when one or more of the UEs are low energy IoT devices.

Hub 914 may have a constant/persistent or intermittent connection to network node 910b. Hub 914 may also allow for a different communication scheme and/or schedule between hub 914 and UEs (e.g., 912c and/or 912d), and between hub 914 and core network 906. In other examples, hub 914 is connected to core network 906 and/or one or more UEs via a wired connection. Moreover, hub 914 may be configured to connect to an M2M service provider over access network 904 and/or to another UE over a direct connection. In some scenarios, UEs may establish a wireless connection with network nodes 910 while still connected via hub 914 via a wired or wireless connection. In some embodiments, hub 914 may be a dedicated hub—that is, a hub whose primary function is to route communications to/from the UEs from/to network node 910b. In other embodiments, hub 914 may be a non-dedicated hub—that is, a device which can route communications between the UEs and network node 910b, but which is additionally capable of operating as a communication start and/or end point for certain data channels.

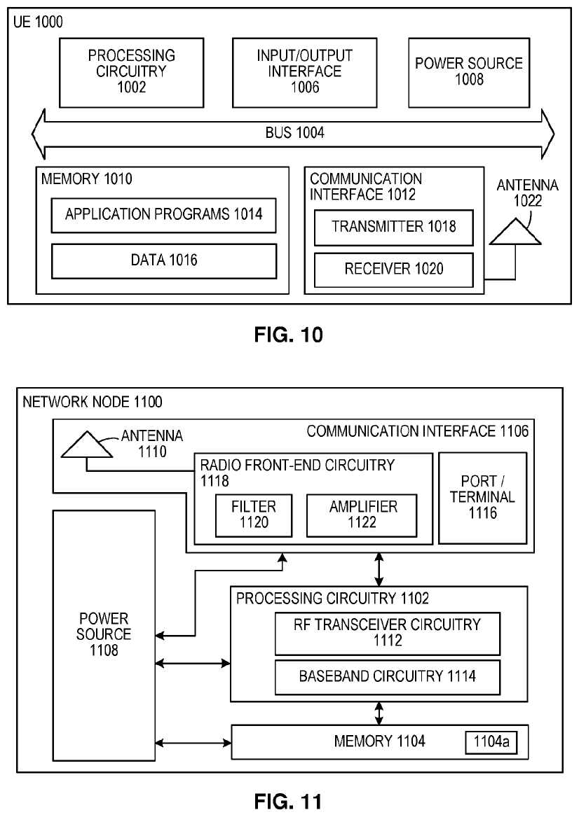

FIG. 10 shows a UE 1000 in accordance with some embodiments. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by 3GPP, including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

UE 1000 includes processing circuitry 1002 that is operatively coupled via bus 1004 to input/output interface 1006, power source 1008, memory 1010, communication interface 1012, and optionally one or more other components not explicitly shown. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

Processing circuitry 1002 is configured to process instructions and data and may be configured to implement any sequential state machine operative to execute instructions stored as machine-readable computer programs in memory 1010. Processing circuitry 1002 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, processing circuitry 1002 may include multiple central processing units (CPUs).

In the example, input/output interface 1006 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into UE 1000. Examples of an input device include a touch-sensitive or presence-sensitive display, a camera (e.g, a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, power source 1008 is structured as a battery or battery pack. Other types of power sources, such as an external power source (e.g., an electricity outlet), photovoltaic device, or power cell, may be used. Power source 1008 may further include power circuitry for delivering power from power source 1008 itself, and/or an external power source, to the various parts of UE 1000 via input circuitry or an interface such as an electrical power cable. Delivering power may be, for example, for charging of power source 1008. Power circuitry may perform any formatting, converting, or other modification to the power from power source 1008 to make the power suitable for the respective components of UE 1000 to which power is supplied.

Memory 1010 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, memory 1010 includes one or more application programs 1014, such as an operating system, web browser application, a widget, gadget engine, or other application, and corresponding data 1016. Memory 1010 may store, for use by UE 1000, any of a variety of various operating systems or combinations of operating systems.

Memory 1010 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as “SIM card.” Memory 1010 may allow UE 1000 to access instructions, application programs and the like, stored on transitory or non-transitory memory media, to off-load data, or to upload data. An article of manufacture, such as one utilizing a communication system may be tangibly embodied as or in memory 1010, which may be or comprise a device-readable storage medium.

Processing circuitry 1002 may be configured to communicate with an access network or other network using communication interface 1012. Communication interface 1012 may comprise one or more communication subsystems and may include or be communicatively coupled to an antenna 1022. Communication interface 1012 may include one or more transceivers used to communicate, such as by communicating with one or more remote transceivers of another device capable of wireless communication (e.g., another UE or a network node in an access network). Each transceiver may include transmitter 1018 and/or receiver 1020 appropriate to provide network communications (e.g., optical, electrical, frequency allocations, and so forth). Moreover, transmitter 1018 and/or receiver 1020 may be coupled to one or more antennas (e.g., 1022) and may share circuit components, software, or firmware, or alternatively be implemented separately.

In the illustrated embodiment, communication functions of communication interface 1012 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1012, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., an alert is sent when moisture is detected), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to UE 1000 shown in FIG. 10.

As another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. For example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 11 shows a network node 1100 in accordance with some embodiments. Examples of network nodes include, but are not limited to, access points (e.g., radio access points) and base stations (e.g., radio base stations, Node Bs, eNBs, and gNBs).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

Network node 1100 includes processing circuitry 1102, memory 1104, communication interface 1106, and power source 1108. Network node 1100 may be composed of multiple physically separate components (e.g., a NodeB component and a RNC component, or a BTS component and a BSC component, etc.), which may each have their own respective components. In certain scenarios in which network node 1100 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, network node 1100 may be configured to support multiple radio access technologies (RATs). In such embodiments, some components may be duplicated (e.g., separate memory 1104 for different RATs) and some components may be reused (e.g., a same antenna 1110 may be shared by different RATs). Network node 1100 may also include multiple sets of the various illustrated components for different wireless technologies integrated into network node 1100, for example GSM, WCDMA, LTE, NR, WiFi. Zigbee, Z-wave, LoRaWAN, Radio Frequency Identification (RFID) or Bluetooth wireless technologies. These wireless technologies may be integrated into the same or different chip or set of chips and other components within network node 1100.

Processing circuitry 1102 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1100 components, such as memory 1104, to provide network node 1100 functionality.

In some embodiments, processing circuitry 1102 includes a system on a chip (SOC). In some embodiments, processing circuitry 1102 includes one or more of radio frequency (RF) transceiver circuitry 1112 and baseband processing circuitry 1114. In some embodiments, RF transceiver circuitry 1112 and baseband processing circuitry 1114 may be on separate chips (or sets of chips), boards, or units, such as radio units and digital units. In alternative embodiments, part or all of RF transceiver circuitry 1112 and baseband processing circuitry 1114 may be on the same chip or set of chips, boards, or units.

Memory 1104 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by processing circuitry 1102. Memory 1104 may store any suitable instructions, data, or information, including a computer program, software, an application including one or more of logic, rules, code, tables, and/or other instructions (collectively denoted computer program 1104a, which may be in the form of a computer program product) capable of being executed by processing circuitry 1102 and utilized by network node 1100. Memory 1104 may be used to store any calculations made by processing circuitry 1102 and/or any data received via communication interface 1106. In some embodiments, processing circuitry 1102 and memory 1104 is integrated.

Communication interface 1106 is used in wired or wireless communication of signaling and/or data between a network node, access network, and/or UE. As illustrated, communication interface 1106 comprises port(s)/terminal(s) 1116 to send and receive data, for example to and from a network over a wired connection. Communication interface 1106 also includes radio front-end circuitry 1118 that may be coupled to, or in certain embodiments a part of, antenna 1110. Radio front-end circuitry 1118 comprises filters 1120 and amplifiers 1122. Radio front-end circuitry 1118 may be connected to an antenna 1110 and processing circuitry 1102. Radio front-end circuitry 1118 may be configured to condition signals communicated between antenna 1110 and processing circuitry 1102. Radio front-end circuitry 1118 may receive digital data that is to be sent out to other network nodes or UEs via a wireless connection. Radio front-end circuitry 1118 may convert the digital data into a radio signal having the appropriate channel and bandwidth parameters using a combination of filters 1120 and/or amplifiers 1122. The radio signal may then be transmitted via antenna 1110. Similarly, when receiving data, antenna 1110 may collect radio signals which are then converted into digital data by radio front-end circuitry 1118. The digital data may be passed to processing circuitry 1102. In other embodiments, the communication interface may comprise different components and/or different combinations of components.

In certain alternative embodiments, network node 1100 does not include separate radio front-end circuitry 1118, instead, processing circuitry 1102 includes radio front-end circuitry and is connected to antenna 1110. Similarly, in some embodiments, all or some of RF transceiver circuitry 1112 can be part of communication interface 1106. In still other embodiments, communication interface 1106 includes one or more ports or terminals 1116, radio front-end circuitry 1118, and RF transceiver circuitry 1112, as part of a radio unit (not shown), and communication interface 1106 communicates with baseband processing circuitry 1114, which is part of a digital unit (not shown).

Antenna 1110 may include one or more antennas, or antenna arrays, configured to send and/or receive wireless signals. Antenna 1110 may be coupled to radio front-end circuitry 1118 and may be any type of antenna capable of transmitting and receiving data and/or signals wirelessly. In certain embodiments, antenna 1110 is separate from network node 1100 and connectable to network node 1100 through an interface or port.

Antenna 1110, communication interface 1106, and/or processing circuitry 1102 may be configured to perform any receiving operations and/or certain obtaining operations described herein as being performed by the network node. Any information, data and/or signals may be received from a UE, another network node and/or any other network equipment. Similarly, antenna 1110, communication interface 1106, and/or processing circuitry 1102 may be configured to perform any transmitting operations described herein as being performed by the network node. Any information, data and/or signals may be transmitted to a UE, another network node and/or any other network equipment.

Power source 1108 provides power to the various components of network node 1100 in a form suitable for the respective components (e.g., at a voltage and current level needed for each respective component). Power source 1108 may further comprise, or be coupled to, power management circuitry to supply the components of network node 1100 with power for performing the functionality described herein. For example, network node 1100 may be connectable to an external power source (e.g., the power grid, an electricity outlet) via an input circuitry or interface such as an electrical cable, whereby the external power source supplies power to power circuitry of power source 1108. As a further example, power source 1108 may comprise a source of power in the form of a battery or battery pack which is connected to, or integrated in, power circuitry. The battery may provide backup power should the external power source fail.

Embodiments of network node 1100 may include additional components beyond those shown in FIG. 11 for providing certain aspects of the network node's functionality, including any of the functionality described herein and/or any functionality necessary to support the subject matter described herein. For example, network node 1100 may include user interface equipment to allow input of information into network node 1100 and to allow output of information from network node 1100. This may allow a user to perform diagnostic, maintenance, repair, and other administrative functions for network node 1100.

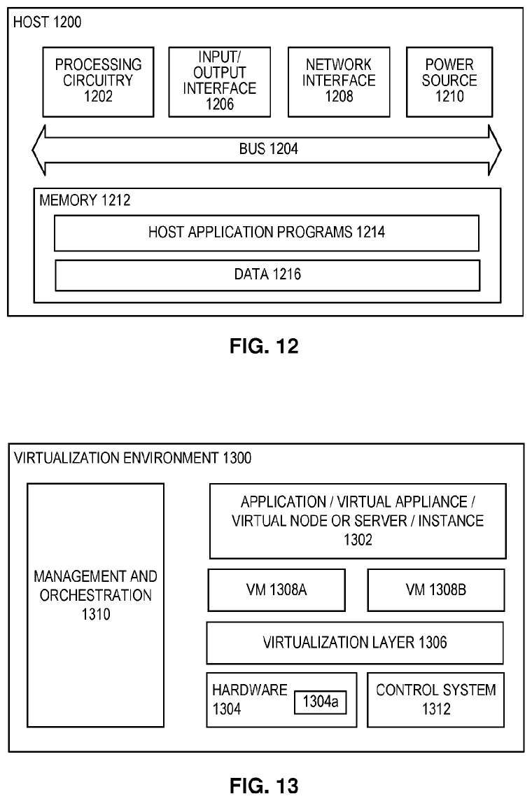

FIG. 12 is a block diagram of a host 1200, which may be an embodiment of host 916 of FIG. 9, in accordance with various aspects described herein. Host 1200 may be or comprise various combinations hardware and/or software, including a standalone server, a blade server, a cloud-implemented server, a distributed server, a virtual machine, container, or processing resources in a server farm. Host 1200 may provide one or more services to one or more UEs.

Host 1200 includes processing circuitry 1202 that is operatively coupled via bus 1204 to input/output interface 1206, network interface 1208, power source 1210, and memory 1212. Other components may be included in other embodiments. Features of these components may be substantially similar to those described with respect to the devices of previous figures, such as FIGS. 10 and 11, such that the descriptions thereof are generally applicable to the corresponding components of host 1200.

Memory 1212 may include one or more computer programs including one or more host application programs 1214 and data 1216, which may include user data, e.g., data generated by a UE for host 1200 or data generated by host 1200 for a UE. Embodiments of host 1200 may utilize all or a subset of the components shown. Host application programs 1214 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). Host application programs 1214 may also provide for user authentication and licensing checks and may periodically report health, routes, and content availability to a central node, such as a device in or on the edge of a core network. Accordingly, host 1200 may select and/or indicate a different host for over-the-top services for a UE. Host application programs 1214 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 13 is a block diagram illustrating a virtualization environment 1300 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1300 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1302 (which may alternatively be called software instances, virtual appliances, network functions, virtual nodes, virtual network functions, etc.) are run in virtualization environment 1300 to implement some of the features, functions, and/or benefits of some of the embodiments disclosed herein.

Hardware 1304 includes processing circuitry, memory that stores software and/or instructions (collectively denoted computer program 1304a, which may be in the form of a computer program product) executable by hardware processing circuitry, and/or other hardware devices as described herein, such as a network interface, input/output interface, and so forth. Software may be executed by the processing circuitry to instantiate one or more virtualization layers 1306 (also referred to as hypervisors or virtual machine monitors (VMMs)), provide VMs 1308a-b (one or more of which may be generally referred to as VMs 1308), and/or perform any of the functions, features and/or benefits described in relation with some embodiments described herein. The virtualization layer 1306 may present a virtual operating platform that appears like networking hardware to the VMs 1308.

VMs 1308 comprise virtual processing, virtual memory, virtual networking or interface and virtual storage, and may be run by a corresponding virtualization layer 1306. Different embodiments of the instance of a virtual appliance 1302 may be implemented on one or more of VMs 1308, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers.

In the context of NFV, each VM 1308 may be a software implementation of a physical machine that runs programs as if they were executing on a physical, non-virtualized machine. Each VM 1308, and that part of hardware 1304 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1308 on top of hardware 1304 and corresponds to application 1302.

Hardware 1304 may be implemented in a standalone network node with generic or specific components. Hardware 1304 may implement some functions via virtualization. Alternatively, hardware 1304 may be part of a larger cluster of hardware (e.g., such as in a data center or CPE) where many hardware nodes work together and are managed via management and orchestration function 1310, which, among others, oversees lifecycle management of applications 1302. In some embodiments, hardware 1304 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of control system 1312 which may alternatively be used for communication between hardware nodes and radio units.

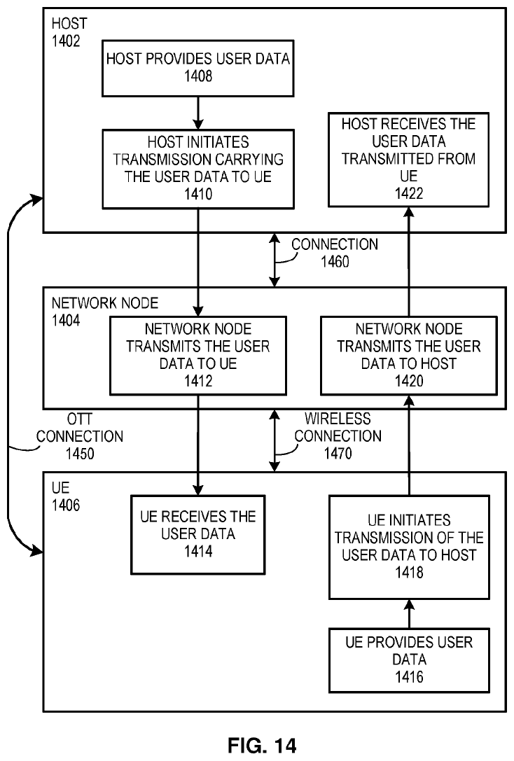

FIG. 14 shows a communication diagram of host 1402 communicating via network node 1404 with UE 1406 over a partially wireless connection in accordance with some embodiments. Example implementations, in accordance with various embodiments, of the UE (such as a UE 912a of FIG. 9 and/or UE 1000 of FIG. 10), network node (such as network node 910a of FIG. 9 and/or network node 1100 of FIG. 11), and host (such as host 916 of FIG. 9 and/or host 1200 of FIG. 12) discussed in the preceding paragraphs will now be described with reference to FIG. 14.

Like host 1200, embodiments of host 1402 include hardware, such as a communication interface, processing circuitry, and memory. Host 1402 also includes software, which is stored in or accessible by host 1402 and executable by the processing circuitry. The software includes a host application that may be operable to provide a service to a remote user, such as UE 1406 connecting via an over-the-top (OTT) connection 1450 extending between UE 1406 and host 1402. In providing the service to the remote user, a host application may provide user data which is transmitted using OTT connection 1450.

Network node 1404 includes hardware enabling it to communicate with host 1402 and UE 1406. Connection 1460 may be direct or pass through a core network (like core network 906 of FIG. 9) and/or one or more other intermediate networks, such as one or more public, private, or hosted networks. For example, an intermediate network may be a backbone network or the Internet.

UE 1406 includes hardware and software, which is stored in or accessible by UE 1406 and executable by the UE's processing circuitry. The software includes a client application, such as a web browser or operator-specific “app” that may be operable to provide a service to a human or non-human user via UE 1406 with the support of host 1402. In host 1402, an executing host application may communicate with the executing client application via OTT connection 1450 terminating at UE 1406 and host 1402. In providing the service to the user, the UE's client application may receive request data from the host's host application and provide user data in response to the request data. OTT connection 1450 may transfer both the request data and the user data. The UE's client application may interact with the user to generate the user data that it provides to the host application through OTT connection 1450.

OTT connection 1450 may extend via a connection 1460 between host 1402 and network node 1404 and via wireless connection 1470 between network node 1404 and UE 1406 to provide the connection between host 1402 and UE 1406. Connection 1460 and wireless connection 1470, over which OTT connection 1450 may be provided, have been drawn abstractly to illustrate the communication between host 1402 and UE 1406 via network node 1404, without explicit reference to any intermediary devices and the precise routing of messages via these devices.

As an example of transmitting data via OTT connection 1450, in step 1408, host 1402 provides user data, which may be performed by executing a host application. In some embodiments, the user data is associated with a particular human user interacting with UE 1406. In other embodiments, the user data is associated with a UE 1406 that shares data with host 1402 without explicit human interaction. In step 1410, host 1402 initiates a transmission carrying the user data towards UE 1406. Host 1402 may initiate the transmission responsive to a request transmitted by UE 1406. The request may be caused by human interaction with UE 1406 or by operation of the client application executing on UE 1406. The transmission may pass via network node 1404, in accordance with the teachings of the embodiments described throughout this disclosure. Accordingly, in step 1412, network node 1404 transmits to UE 1406 the user data that was carried in the transmission that host 1402 initiated, in accordance with the teachings of the embodiments described throughout this disclosure. In step 1414, UE 1406 receives the user data carried in the transmission, which may be performed by a client application executed on UE 1406 associated with the host application executed by host 1402.

In some examples, UE 1406 executes a client application which provides user data to host 1402. The user data may be provided in reaction or response to the data received from host 1402. Accordingly, in step 1416, UE 1406 may provide user data, which may be performed by executing the client application. In providing the user data, the client application may further consider user input received from the user via an input/output interface of UE 1406. Regardless of how the user data was provided, UE 1406 initiates, in step 1418, transmission of the user data towards host 1402 via network node 1404. In step 1420, in accordance with the teachings of the embodiments described throughout this disclosure, network node 1404 receives user data from UE 1406 and initiates transmission of the received user data towards host 1402. In step 1422, host 1402 receives the user data carried in the transmission initiated by UE 1406.

One or more of the various embodiments improve the performance of OTT services provided to UE 1406 using OTT connection 1450, in which the wireless connection 1470 forms the last segment. More precisely, embodiments described can provide various benefits and/or advantages. For example, embodiments can increase likelihood of successful decoding of UE UL traffic since a RAN node will receive a UE's msgA PUSCH transmission correctly time-aligned, whereas in conventional solutions the RAN node must apply a time shift based on reception of the msgA RA preamble. Likewise, embodiments facilitate use of the more efficient, two-step RA by UEs located further away from the RAN node as compared to conventional techniques. Embodiments can also facilitate direct UE transmission in PUSCH or PUCCH resources based on a stored TA value without transmitting an accompanying RA preamble, thereby reducing PRACH load. Embodiments provide such benefits and/or advantages without requiring any reservation of UL resources for a UE response to MT-SDT, which is beneficial in cases of no response or a response with long latency. When UEs and RAN nodes improved in this manner are used to deliver OTT services to end users, they increase the value of these OTT services to the end users and to the OTT service provider.

In an example scenario, factory status information may be collected and analyzed by host 1402. As another example, host 1402 may process audio and video data which may have been retrieved from a UE for use in creating maps. As another example, host 1402 may collect and analyze real-time data to assist in controlling vehicle congestion (e.g., controlling traffic lights). As another example, host 1402 may store surveillance video uploaded by a UE. As another example, host 1402 may store or control access to media content such as video, audio. VR or AR which it can broadcast, multicast or unicast to UEs. As other examples, host 1402 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency, and other factors on which the one or more embodiments improve. There may further be an optional network functionality for reconfiguring OTT connection 1450 between host 1402 and UE 1406, in response to variations in the measurement results. The measurement procedure and/or the network functionality for reconfiguring the OTT connection may be implemented in software and hardware of host 1402 and/or UE 1406. In some embodiments, sensors (not shown) may be deployed in or in association with other devices through which OTT connection 1450 passes; the sensors may participate in the measurement procedure by supplying values of the monitored quantities exemplified above, or supplying values of other physical quantities from which software may compute or estimate the monitored quantities. The reconfiguring of OTT connection 1450 may include message format, retransmission settings, preferred routing etc.; the reconfiguring need not directly alter the operation of network node 1404. Such procedures and functionalities may be known and practiced in the art. In certain embodiments, measurements may involve proprietary UE signaling that facilitates measurements of throughput, propagation times, latency, and the like, by host 1402. The measurements may be implemented in that software causes messages to be transmitted (e.g., empty or ‘dummy’ messages) using OTT connection 1450 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for performing one or more of the techniques described herein. In some implementations, the processing circuitry may be used to cause the respective functional unit to perform corresponding functions according to one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

Embodiments of the techniques and apparatus described herein also include, but are not limited to, the following enumerated examples:

A1. A method for a user equipment (UE) configured to operate in a cell served by a radio access network (RAN) node, the method comprising:
receiving the following from the RAN node during a first procedure:
   downlink (DL) data associated with an application, and
   a timing advance (TA) command applicable to UE uplink (UL) transmissions to the RAN node;
initiating a time alignment timer (TAT) in response to receiving the TA command;
subsequently receiving responsive UL data from the application; and
based on determining that the TAT has not expired, transmitting to the RAN node one or more messages associated with the UL data, according to a timing adjusted based on the received TA command.
   A2. The method of embodiment A1, wherein the one or more messages include a physical uplink shared channel (PUSCH) message comprising at least a portion of the UL data.
   A3. The method of embodiment A2, wherein the PUSCH message includes a first portion of the UL data and a buffer status report (BSR) indicating a second portion of the UL data remaining to be transmitted.
   A4. The method of any of embodiments A2-A3, wherein the PUSCH message is transmitted on one of the following:
UE-specific PUSCH resources, for which the UE obtained a grant during the first procedure; or
non-UE specific PUSCH resources, which are indicated by system information (SI) broadcast in the cell.
   A5. The method of embodiment A4, wherein:
the TAT is initiated to a value corresponding to a duration that the UE remains UL synchronized with the cell; and
the UE-specific PUSCH resources are at one or more instances before TAT expiration at the end of the duration.
   A6. The method of embodiment A4, wherein the UE-specific PUSCH resources are at one or more instances before a longest expected delay between receiving the DL data and transmitting an initial one of the messages associated with the UL data.
   A7. The method of any of embodiments A2-A6, wherein the one or more messages also include a random access (RA) preamble.
   A8. The method of embodiment A7, wherein the RA preamble is transmitted concurrently with the PUSCH message as part of a two-step RA procedure.
   A9. The method of embodiment A8, further comprising selecting the two-step RA procedure instead of a four-step RA procedure according to one of the following:
reference signal received power (RSRP) measured in the cell is greater than an RSRP threshold that is lower than a corresponding RSRP threshold associated with a default timing for the RA preamble and the PUSCH message;
independent of any RSRP thresholds associated with distance from an antenna associated with the cell.
   A10. The method of any of embodiments A7-A9, wherein the RA preamble is one of the following:
a contention-based RA (CBRA) preamble; or
a contention-free RA (CFRA) preamble, which the UE obtains from the RAN node during the first procedure.
   A11. The method of embodiment A10, wherein:
the CFRA preamble is one of a plurality of CFRA preambles obtained by the UE during the first procedure;
each of the obtained CFRA preambles is associated with a different size of PUSCH resources; and
the method further comprises selecting the CFRA preamble from the plurality of obtained CFRA preambles based on an amount of PUSCH resources needed to carry the UL data.
   A12. The method of embodiment A11, wherein:
the method further comprising receiving from the RAN node downlink control information (DCI) including a grant of UL resources to carry the UL data;
the grant of UL resources is based on the size of PUSCH resources associated with the transmitted CFRA preamble; and
the PUSCH message is transmitted on the granted UL resources.
   A13. The method of any of embodiments A2-A11, wherein:
the one or more messages also include a scheduling request (SR) for UL resources to carry the UL data;
the method further comprises, in response to the SR, receiving from the RAN node downlink control information (DCI) including a grant of UL resources to carry the UL data; and
the PUSCH message is transmitted on the granted UL resources.
   A14. The method of embodiment A13, wherein the SR is transmitted via physical uplink control channel (PUCCH) resources and one of the following applies:
the PUCCH resources are UE-specific and are obtained from the RAN node during the first procedure; or
the PUCCH resources are non-UE-specific and are indicated by system information (SI) broadcast in the cell
   A15. The method of embodiment A14, wherein when the PUCCH resources are non-UE-specific, the PUSCH message includes an identifier of the UE.
   A16. The method of any of embodiments A1-A15, wherein the first procedure is a mobile-terminated small data transmission (MT-SDT) procedure.
   B1. A method for a radio access network (RAN) node configured to communicate with user equipment (UEs) via a cell, the method comprising:
transmitting the following to a UE during a first procedure:
   downlink (DL) data associated with an application, and
   a timing advance (TA) command applicable to UE uplink (UL) transmissions to the RAN node; and
subsequently receiving from the UE one or more messages associated with responsive UL data from the application, wherein the one or more messages are received according to a timing based to the TA command and before expiration of a time alignment timer (TAT) initiated by the UE in response to the TA command.
   B2. The method of embodiment B1, wherein the one or more messages include a physical uplink shared channel (PUSCH) message comprising at least a portion of the UL data.
   B2a. The method of embodiment B2, wherein:
the one or more messages do not include a random access (RA) preamble; and
receiving the one or more messages comprises detecting the PUSCH message based on performing blind decoding of PUSCH candidates.
   B2b. The method of embodiment B2a, wherein
the RAN node also provided a contention-free RA (CFRA) preamble to the UE during the first procedure; and
detecting the PUSCH message is based on performing blind decoding of PUSCH candidates in PUSCH resources associated with the CFRA preamble.
   B3. The method of embodiment B2, wherein the PUSCH message includes a first portion of the UL data and a buffer status report (BSR) indicating a second portion of the UL data remaining to be transmitted.
   B4. The method of any of embodiments B2-B3, wherein the PUSCH message is received on one of the following:
UE-specific PUSCH resources, for which the RAN node provided a grant to the UE during the first procedure; or
non-UE specific PUSCH resources, which are indicated system information (SI) broadcast in the cell.
   B5. The method of embodiment B4, wherein:
the TAT is initiated to a value corresponding to a duration that the UE remains UL synchronized with the cell; and
the UE-specific PUSCH resources are at one or more instances before TAT expiration at the end of the duration.
   B6. The method of embodiment B4, wherein the UE-specific PUSCH resources are at one or more instances before a longest expected delay between transmitting the DL data and receiving an initial one of the messages associated with the UL data.
   B7. The method of any of embodiments B2-B6, wherein the one or more messages also include a random access (RA) preamble.
   B8. The method of embodiment B7, wherein the RA preamble is received concurrently with the PUSCH message as part of a two-step RA procedure.
   B9. The method of embodiment B8, wherein use of the two-step RA procedure instead of a four-step RA procedure is according to one of the following:
a reference signal received power (RSRP) threshold that is lower than a corresponding RSRP threshold associated with a default timing for the RA preamble and the PUSCH message; or
independent of any RSRP thresholds associated with distance from an antenna associated with the cell.
   B10. The method of any of embodiments B7-B9, wherein the RA preamble is one of the following:
a contention-based RA (CBRA) preamble; or
a contention-free RA (CFRA) preamble, which the RAN node provides to the UE during the first procedure.
   B11. The method of embodiment B10, wherein:
the CFRA preamble is one of a plurality of CFRA preambles provided to the UE during the first procedure; and
each of the plurality of CFRA preambles is associated with a different size of PUSCH resources.
   B12. The method of embodiment B11, wherein:
the method further comprising transmitting to the UE downlink control information (DCI) including a grant of UL resources to carry the UL data;
the grant of UL resources is based on the size of PUSCH resources associated with the received CFRA preamble; and
the PUSCH message is received on the granted UL resources.
   B13. The method of any of embodiments B2-B11, wherein:
the one or more messages also include a scheduling request (SR) for UL resources to carry the UL data;
the method further comprises transmitting to the UE downlink control information (DCI) including a grant of UL resources to carry the UL data; and
the PUSCH message is received on the granted UL resources.
   B14. The method of embodiment B13, wherein the SR is received via physical uplink control channel (PUCCH) resources and one of the following applies:
the PUCCH resources are UE-specific, and were provided by the RAN node during the first procedure; or
the PUCCH resources are non-UE-specific and are indicated by system information (SI) broadcast in the cell
   B15. The method of embodiment B14, wherein when the PUCCH resources are non-UE-specific, the PUSCH message includes an identifier of the UE.
   B16. The method of any of embodiments B1-B15, wherein the first procedure is a mobile-terminated small data transmission (MT-SDT) procedure.
   C1. A user equipment (UE) configured to operate in a cell served by a radio access network (RAN) node, the UE comprising:
communication interface configured to communicate with the RAN node via the cell; and
processing circuitry operatively coupled to the communication interface circuitry, whereby the processing circuitry and the communication interface circuitry are configured to perform operations corresponding to any of the methods of embodiments A1-A16.
   C2. A user equipment (UE) configured to operate in a cell served by a radio access network (RAN) node, the UE being further configured to perform operations corresponding to any of the methods of embodiments A1-A16.
   C3. A non-transitory, computer-readable medium storing computer-executable instructions that, when executed by processing circuitry of a user equipment (UE) configured to operate in a cell served by a radio access network (RAN) node, configure the UE to perform operations corresponding to any of the methods of embodiments A1-A16.
   C4. A computer program product comprising computer-executable instructions that, when executed by processing circuitry of a user equipment (UE) configured to operate in a cell served by a radio access network (RAN) node, configure the UE to perform operations corresponding to any of the methods of embodiments A1-A16.
   D1. A radio access network (RAN) node configured to communicate with user equipment (UEs) via a cell, the RAN node comprising:
communication interface circuitry configured to communicate with UEs; and
processing circuitry operatively coupled to the communication interface circuitry, whereby the processing circuitry and the communication interface circuitry are configured to perform operations corresponding to any of the methods of embodiments B1-B16.
   D2. A radio access network (RAN) node configured to communicate with user equipment (UEs) via a cell, the RAN node being further configured to perform operations corresponding to any of the methods of embodiments B1-B16.
   D3. A non-transitory, computer-readable medium storing computer-executable instructions that, when executed by processing circuitry of radio access network (RAN) node configured to communicate with user equipment (UEs) via a cell, configure the RAN node to perform operations corresponding to any of the methods of embodiments B1-B16.
   D4. A computer program product comprising computer-executable instructions that, when executed by processing circuitry of radio access network (RAN) node configured to communicate with user equipment (UEs) via a cell, configure the RAN node to perform operations corresponding to any of the methods of embodiments B1-B16.

1.-52. (canceled)

53. A method for a user equipment (UE) configured to operate in a cell served by a radio access network (RAN) node, the method comprising:
receiving at least the following information from the RAN node during a first procedure:
downlink (DL) data associated with an application hosted by the UE, and
a timing advance (TA) command applicable to UE uplink (UL) transmissions to the RAN node;
initiating a time alignment timer (TAT) in response to the TA command; and
after completion of the first procedure and based on determining that the TAT has not expired, transmitting to the RAN node one or more messages, wherein the transmission is according to a timing adjusted based on the TA command.

54. The method of claim 53, further comprising receiving UL data from the application after completion of the first procedure, wherein the one or more messages are associated with the UL data.

55. The method of claim 54, wherein the one or more messages include a physical uplink shared channel (PUSCH) message comprising at least a portion of the UL data.

56. The method of claim 55, wherein the PUSCH message is transmitted on one of the following:
UE-specific PUSCH resources, for which the UE received a grant from the RAN node during the first procedure; or
non-UE specific PUSCH resources, which are indicated by system information broadcast in the cell.

57. The method of claim 56, wherein:
the TAT is initiated to a value corresponding to a duration that the UE remains UL synchronized with the cell; and
the UE-specific PUSCH resources are granted at one or more instances before TAT expiration at the end of the duration.

58. The method of claim 56, wherein the UE-specific PUSCH resources are granted at one or more instances after reception of the DL data but before a longest expected delay between reception of the DL data and transmission of an initial one of the messages according to the timing adjusted based on the TA command.

59. The method of claim 55, wherein the one or more messages also include a random access (RA) preamble.

60. The method of claim 55, wherein:
the one or more messages also include a scheduling request (SR) for UL resources to carry the UL data;
the method further comprises, in response to the SR, receiving from the RAN node a physical downlink control channel (PDCCH) message including a grant of UL resources to carry the UL data; and
the PUSCH message is transmitted on the UL resources of the grant.

61. The method of claim 60, wherein:
the information received from the RAN node during the first procedure also includes a UE-specific radio network temporary identifier (RNTI); and
the SR is transmitted on one of the following:
UE-specific physical uplink control channel (PUCCH) resources, for which the UE received a previous grant from the RAN node during the first procedure; or
non-UE-specific PUCCH resources, which are indicated by system information broadcast in the cell.

62. The method of claim 60, wherein when the PDCCH message is received together with an updated TA command, the PUSCH message is transmitted according to a timing adjusted based on the updated TA command.

63. A method for a radio access network (RAN) node configured to communicate with user equipment (UEs) via a cell, the method comprising:
transmitting at least the following information to a UE during a first procedure:
downlink (DL) data associated with an application hosted by the UE, and
a timing advance (TA) command applicable to UE uplink (UL) transmissions to the RAN node; and
after completion of the first procedure and before expiration of a time alignment timer (TAT) initiated by the UE in response to the TA command, receiving from the UE one or more messages, wherein the reception is according to a timing based on the TA command.

64. The method of claim 63, wherein:
the one or more messages are associated with UL data from the application;
the one or more messages include a physical uplink shared channel (PUSCH) message comprising at least a portion of the UL data;
the one or more messages do not include a random access (RA) preamble; and
receiving the one or more messages comprises detecting the PUSCH message based on performing blind decoding of PUSCH candidates.

65. The method of claim 64, wherein
the information transmitted to the UE during the first procedure also includes an indication of a contention-free RA (CFRA) preamble; and
detecting the PUSCH message is based on performing blind decoding of PUSCH candidates in PUSCH resources associated with the CFRA preamble.

66. The method of claim 64, wherein the PUSCH message includes a first portion of the UL data and a buffer status report (BSR) indicating a second portion of the UL data remaining to be transmitted.

67. The method of claim 64, wherein the PUSCH message is received on one of the following:
UE-specific PUSCH resources, for which the RAN node transmitted a grant to the UE during the first procedure; or
non-UE specific PUSCH resources, which are indicated by system information broadcast in the cell.

68. The method of claim 64, wherein the one or more messages also include a random access (RA) preamble.

69. The method of claim 64, wherein:
the one or more messages also include a scheduling request (SR) for UL resources to carry the UL data;
the method further comprises, in response to the SR, transmitting to the UE a physical downlink control channel (PDCCH) message including a grant of UL resources to carry the UL data; and
the PUSCH message is received on the UL resources of the grant.

70. The method of claim 69, wherein:
the information transmitted to the UE during the first procedure also includes a UE-specific radio network temporary identifier (RNTI); and
the SR is received on one of the following:
UE-specific physical uplink control channel (PUCCH) resources, for which the RAN node transmitted a previous grant to the UE during the first procedure; or
non-UE-specific PUCCH resources, which are indicated by system information broadcast in the cell.

71. A user equipment (UE) configured to operate in a cell served by a radio access network (RAN) node, the UE comprising:
communication interface circuitry configured to communicate with the RAN node via the cell; and
processing circuitry operatively coupled to the communication interface circuitry, wherein the processing circuitry and the communication interface circuitry are configured to:
receive at least the following information from the RAN node during a first procedure:
downlink (DL) data associated with an application hosted by the UE, and
a timing advance (TA) command applicable to UE uplink (UL) transmissions to the RAN node;
initiate a time alignment timer (TAT) in response to TA command; and
after completion of the first procedure, and based on a determination that the TAT has not expired, transmit to the RAN node one or more messages, wherein the transmission is according to a timing adjusted based on the TA command.

72. A radio access network (RAN) node configured to communicate with user equipment, UEs via a cell, the RAN node comprising:
communication interface circuitry configured to communicate with UEs via the cell; and
processing circuitry operatively coupled to the communication interface circuitry, wherein the processing circuitry and the communication interface circuitry are configured to:
transmit at least the following information to a UE during a first procedure:
downlink (DL) data associated with an application hosted by the UE, and
a timing advance (TA) command applicable to UE uplink (UL) transmissions to the RAN node; and
after completion of the first procedure and before expiration of a time alignment timer (TAT) initiated by the UE in response to the TA command, receive from the UE one or more messages, wherein the reception is according to a timing based on the TA command.
